(19) United States
(12) Patent Application Publication
(10) Pub. No.: US 2026/0068908 A1
(43) Pub. Date: Mar. 12, 2026

(54) SYSTEMS, METHODS, AND COMPOSITIONS FOR PRODUCTION OF CELLULAR AGRICULTURE PROTEIN PRODUCTS

(71) Applicant: ALCHEME BIO INC., Dover, DE (US)

(72) Inventor: Vanessa Small, San Diego, CA (US)

(73) Assignee: ALCHEME BIO INC., Dover, DE (US)

(21) Appl. No.: 19/319,578

(22) Filed: Sep. 4, 2025

Related U.S. Application Data
(60) Provisional application No. 63/692,708, filed on Sep. 9, 2024.
(60) Provisional application No. 63/765,492, filed on Feb. 28, 2025.

(51) Int. Cl. A23J 3/34; A23J 3/14

(52) U.S. Cl. CPC A23J 3/346; A23J 3/14

(57) ABSTRACT

Culture supplement compositions for cellular agriculture protein production include a formulation including, in a carrier, at least one enzyme configured to modify a base cellular agriculture protein product to produce an adjusted cellular agriculture protein product having reduced off-flavor compounds compared to the base cellular agriculture protein product. Cellular agriculture products made from culture supplement compositions and systems and methods for cellular agriculture protein production are also provided.

### CROSS-REFERENCE TO RELATED APPLICATIONS

This application claims priority to U.S. provisional application Nos. 63/692,708, filed Sep. 9, 2024, and 63/765,492, filed Feb. 28, 2025, each of which is incorporated by reference herein in its entirety.

### BACKGROUND

### Field

The disclosed subject matter relates to cellular agriculture products, including systems, methods, and compositions used for production of cellular agriculture products including protein products.

### Description of Related Art

Cellular agriculture products generally refer to agricultural items, such as food materials, or other products produced using cell cultures. This can include both acellular products and cellular products derived from cell cultures. Cellular agriculture products can provide several advantages over traditional agriculture products, including reduced environmental impact, lack of animal welfare concerns, increased product security, and enhanced product safety.

However, cellular agriculture products, including protein products, can lack desirable attributes compared to traditional protein products. Dairy proteins, such as casein and whey proteins, can be produced through precision fermentation using engineered microorganisms, but these cellular agriculture dairy proteins can exhibit flavor profiles that differ from traditional dairy products. Plant-based proteins, including leguminous proteins such as pea protein, mung bean protein, and fava bean protein, can be incorporated into cellular agriculture applications but can present undesirable sensory attributes including bitter, beany, and astringent off-notes that reduce commercial appeal and consumer acceptance.

Leguminous proteins can present challenges in cellular agriculture applications. While pea protein, for example, offers high protein content, sustainability benefits, and functional properties suitable for cellular agriculture scaffolds and plant-based analogues, pea protein can contain anti-nutritional factors such as phytic acid, oligosaccharides, and protease inhibitors that reduce digestibility and nutritional bioavailability. Additionally, saponins, polyphenols, and oxidized lipids in leguminous proteins can contribute to undesirable flavors that detract from the sensory experience of cellular agriculture products.

To overcome these deficiencies, producers of cellular agriculture products can apply additives to improve less desirable attributes. In protein products, manufacturers can use masking agents, flavor additives, or extensive processing techniques to improve palatability. Such additive techniques have disadvantages, including additional cost, greater production complexity, and longer ingredient labels. Furthermore, additives can mask, but can fail to eliminate, undesirable attributes, and can be insufficient to replicate desirable attributes for which no suitable additives exist. Additionally, cellular agriculture protein products can serve as neutral ingredient bases for end-product manufacturers. Such protein ingredients can provide food and beverage manufacturers with ingredients having functional benefits without contributing unwanted sensory characteristics that may interfere with desired final product profiles.

Current processing techniques for improving protein attributes, including heat treatment, fermentation, and chemical extraction, can result in loss of protein functionality, increased production costs, and inconsistent attribute modification. These approaches thus can fail to adequately modify molecular components responsible for undesirable sensory or nutritional characteristics while preserving beneficial protein properties.

Accordingly, there is an opportunity for cellular agriculture protein products having attributes that more closely align with consumer preferences and emulate desirable attributes of traditional protein products, as well as cellular agriculture protein products having neutral sensory profiles that can serve as versatile ingredient bases for commercial applications. Such products can be produced having desired attributes during the growth or expression phase, reducing or eliminating the use of additives. Moreover, there is an opportunity for approaches that can modify protein substrates at the molecular level to achieve desired sensory and functional outcomes while maintaining a clean ingredient label and production efficiency, including for example systems and methods that can reduce undesirable compounds while enhancing beneficial characteristics or substantially eliminate off-flavor compounds to achieve neutral flavor profiles suitable for ingredient applications.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the devices, methods and compositions particularly pointed out in the written description and claims hereof, as well as from the drawings.

To achieve these and other advantages and in accordance with the purpose of the disclosed subject matter, as embodied and broadly described, the disclosed subject matter includes a culture supplement composition for producing an adjusted cellular dairy product having a formulation including, in a carrier, at least one enzyme, where the formulation is configured to adjust production of a base cellular dairy product including cellular dairy proteins to produce an adjusted cellular dairy product having increased alignment of one or more dairy attributes with a target reference compared to the base cellular dairy product without reducing cellular growth or cellular viability.

As embodied herein, the target reference can include a reference dairy product. Additionally or alternatively, the reference dairy product can include one or more of a traditional dairy product, cow's milk, cheese, yogurt, or an animal-based dairy protein having desired sensory characteristics. Furthermore, or as an alternative, the target reference can include a neutral flavor profile having reduced off-flavor compounds. Moreover, as embodied herein, the one or more dairy attributes can include one or more of flavor profiles, odor profiles, taste characteristics including sourness, sweetness, and saltiness, texture, or color.

As embodied herein, the at least one enzyme can be selected from the group consisting of 9-lipoxygenase, 13-lipoxygenase, hydroperoxide lyases, alcohol dehydrogenases, isomerases, fatty acid desaturases, cyclooxygenases, elongases, oxidoreductases, transferases, endopeptidases, exopeptidases, hydrolases, lyases, and ligases. Additionally or alternatively, the formulation can further include one or more substrates selected from the group consisting of linoleic acid, linolenic acid, saturated fatty acids, monounsaturated fatty acids, polyunsaturated fatty acids, omega-3 fatty acids, omega-6 fatty acids, peptides, proteins, nucleotides, and amino acids. Furthermore, or as an alternative, the formulation can further include one or more additives selected from the group consisting of growth factor proteins, insulin hormones, transport proteins, and peptides configured to support cellular agriculture production.

Moreover, as embodied herein, the carrier can include one or more of an emulsifier solution having a concentration from 0.5% v/v to 5% v/v, powder, gel, or solid substrate. Additionally or alternatively, the emulsifier solution can include one or more of a nonionic detergent, a nonionic triblock copolymer, a nonionic surfactant, a poloxamer, or a zwitterionic detergent. As embodied herein, the formulation can be configured to be added to a cell culture medium of the base cellular dairy product at a concentration from 1% v/v to 15% v/v during at least one of a growth phase, an expression phase, a rehydration phase, or a structuring phase. In addition, or as a further alternative, the formulation can be configured to generate one or more volatile organic compounds contributing to the one or more dairy attributes, including one or more of butanoic acid, hexanoic acid, butyl butanoate, pentanoic acid, 2-heptanone, 2-methylpropanoic acid, aldehydes, and esters.

According to other aspects of the disclosed subject matter, a method for cellular attribute alignment of a base cellular dairy product includes accessing, using processing circuitry and first data stored in memory, a compositional profile of one or more target compounds affecting one or more dairy attributes of a target reference, determining, using the processing circuitry, at least one compositional gap in the base cellular dairy product by comparison of the compositional levels of the one or more target compounds in the first data to corresponding compositional levels in second data including a compositional profile of the base cellular dairy product, and providing, using the processing circuitry, a culture supplement composition including a formulation including, in a carrier, at least one enzyme, where the formulation is configured to adjust production of the base cellular dairy product including cellular dairy proteins to produce an adjusted cellular dairy product having increased alignment of one or more dairy attributes with the target reference compared to the base cellular dairy product without reducing cellular growth or cellular viability.

As embodied herein, the target reference can include a reference product compositional profile. Additionally or alternatively, the reference product can include one or more of a traditional dairy product, cow's milk, cheese, yogurt, an animal-based dairy protein, a traditional protein product, or a naturally-occurring protein product having desired sensory, functional, or nutritional characteristics. Furthermore, or as an alternative, the target reference can include a neutral flavor profile having reduced off-flavor compounds. Moreover, as embodied herein, the base cellular dairy product can include one or more of a precision fermented protein, a cellular dairy protein, casein, or whey protein.

As embodied herein, the one or more dairy attributes can include one or more of flavor profiles, odor profiles, volatile organic compound profiles, and taste attributes including sourness, sweetness, and saltiness, nutritional components, digestibility, functional properties, solubility, texture, color, or elasticity. Additionally or alternatively, the compositional profiles can include measurements of one or more molecular components selected from the group consisting of volatile organic compounds including aldehydes, alcohols, ketones, esters, acids, and hydrocarbons, taste-active compounds, hexanal, butanoic acid, hexanoic acid, butyl butanoate, pentanoic acid, 2-heptanone, 2-methylpropanoic acid, benzaldehyde, and dairy-associated flavor compounds. Furthermore, or as an alternative, the compositional profiles of the first data and the second data each can include data obtained using one or more analytical techniques selected from the group consisting of electronic nose analysis configured to detect and quantify volatile organic compounds, electronic tongue analysis configured to detect and quantify taste-active compounds, gas chromatography, mass spectrometry, liquid chromatography, nuclear magnetic resonance spectroscopy, infrared spectroscopy, and principal component analysis.

Moreover, as embodied herein, the at least one enzyme can be selected from the group consisting of lipoxygenase, hydroperoxide lyases, alcohol dehydrogenases, isomerases, fatty acid desaturases, cyclooxygenases, elongases, oxidoreductases, transferases, endopeptidases, exopeptidases, hydrolases, lyases, and ligases. Additionally or alternatively, the culture supplement composition can further include one or more substrates selected from the group consisting of linoleic acid, linolenic acid, saturated fatty acids, monounsaturated fatty acids, polyunsaturated fatty acids, omega-3 fatty acids, omega-6 fatty acids, peptides, proteins, nucleotides, and amino acids. As embodied herein, the culture supplement composition can be configured to implement targeted enzyme pathways for generating flavor-active compounds contributing to buttery, nutty, and creamy sensory notes characteristic of traditional dairy products. In addition, or as a further alternative, the culture supplement composition can be applied during at least one of a growth phase, an expression phase, a rehydration phase, or a structuring phase without reducing cellular growth or cellular viability.

According to other aspects of the disclosed subject matter, a system for cellular attribute alignment of a base cellular dairy product includes one or more memories configured to store first data including one or more target compounds affecting one or more dairy attributes of a target reference and second data including a compositional profile of a base cellular dairy product, and processing circuitry configured to identify, using the first data, one or more target compounds affecting the one or more dairy attributes, determine at least one compositional gap in the base cellular dairy product by comparison of compositional levels of the one or more target compounds, and provide a culture supplement composition including a formulation including, in a carrier, at least one enzyme, where the formulation is configured to adjust production of the base cellular dairy product including cellular dairy proteins to produce an adjusted cellular dairy product having increased alignment of one or more dairy attributes with the target reference compared to the base cellular dairy product.

As embodied herein, the system can further include an extraction-quantification component in communication with the processing circuitry and configured to generate compositional profile data for one or more of the base cellular dairy product, the target reference, and the adjusted cellular dairy product. Additionally or alternatively, the extraction-quantification component can include one or more of a digital nose system configured to identify volatile organic compounds and generate electronic signatures that correlate with human sensory perception, and a digital tongue system configured to detect and quantify taste-active compounds using sensor arrays.

Furthermore, or as an alternative, the target reference can include a reference product compositional profile. Moreover, as embodied herein, the reference product can include one or more of a traditional dairy product, cow's milk, cheese, yogurt, an animal-based dairy protein, a traditional protein product, or a naturally-occurring product having desired sensory, functional, or nutritional characteristics. Additionally or alternatively, the target reference can include a neutral flavor profile having reduced off-flavor compounds. As embodied herein, the one or more dairy attributes can include one or more of flavor profiles, odor profiles, volatile organic compound profiles, and taste attributes including sourness, sweetness, and saltiness, nutritional components, digestibility, functional properties, solubility, texture, color, or elasticity.

In addition, or as a further alternative, the system can further include a manufacturing component configured to produce the adjusted cellular dairy product, where the manufacturing component can include one or more of a bioreactor, a production vessel, a shake flask, a mixer, or a drying module configured to produce precision fermented proteins, cellular dairy proteins, or cultivated foods. Furthermore, or as an alternative, the processing circuitry can be configured to analyze the compositional profiles of the first data or the second data using one or more analytical techniques selected from the group consisting of principal component analysis, multivariate statistical analysis, electronic nose analysis, volatile organic compound identification, electronic tongue analysis, taste attribute quantification, and standards addition methodology.

Moreover, as embodied herein, the base cellular dairy product can include one or more of a precision fermented protein, a cellular dairy protein, casein, or whey protein. Additionally or alternatively, the at least one enzyme can be selected from the group consisting of lipoxygenase, hydroperoxide lyases, alcohol dehydrogenases, isomerases, fatty acid desaturases, cyclooxygenases, elongases, oxidoreductases, transferases, endopeptidases, exopeptidases, hydrolases, lyases, and ligases. As embodied herein, the culture supplement composition can further include one or more substrates selected from the group consisting of linoleic acid, linolenic acid, saturated fatty acids, monounsaturated fatty acids, polyunsaturated fatty acids, omega-3 fatty acids, omega-6 fatty acids, peptides, proteins, nucleotides, and amino acids. In addition, or as a further alternative, the processing circuitry can be configured to add the culture supplement composition at a concentration from 1% v/v to 15% v/v during at least one of a growth phase, an expression phase, a rehydration phase, or a structuring phase.

According to other aspects of the disclosed subject matter, adjusted cellular dairy products are provided. In accordance with the disclosed subject matter herein, an adjusted cellular dairy product is produced using a culture supplement composition including a formulation including, in a carrier, at least one enzyme configured to adjust production of a base cellular dairy product including cellular dairy proteins to produce an adjusted cellular dairy product having increased alignment of one or more dairy attributes with a target reference compared to the base cellular dairy product, where the adjusted cellular dairy product has increased alignment of the one or more dairy attributes with the target reference compared to the base cellular dairy product.

As embodied herein, the target reference can include a reference dairy product. Additionally or alternatively, the reference dairy product can include one or more of a traditional dairy product, cow's milk, cheese, yogurt, or an animal-based dairy protein having desired sensory characteristics. Furthermore, or as an alternative, the target reference can include a neutral flavor profile having reduced off-flavor compounds. Moreover, as embodied herein, the dairy attributes can include one or more of flavor profiles, odor profiles, taste characteristics including sourness, sweetness, and saltiness, texture, or color.

As embodied herein, the adjusted cellular dairy product can contain volatile organic compounds including butanoic acid, hexanoic acid, butyl butanoate, pentanoic acid, 2-heptanone, 2-methylpropanoic acid, aldehydes, and esters that contribute to dairy odor profiles. Additionally or alternatively, the cellular dairy product can include one or more of precision fermented dairy proteins, cellular casein, cellular whey protein, or cultivated dairy products. Furthermore, or as an alternative, the adjusted cellular dairy product can exhibit flavor-active compounds contributing to buttery, nutty, and creamy sensory notes characteristic of traditional dairy products.

Moreover, as embodied herein, the adjusted cellular dairy product can be selected from the group consisting of protein powders, protein concentrates, protein isolates, liquid protein formulations, and spray-dried protein ingredients. Additionally or alternatively, the increased alignment can be achieved without reducing cellular growth or cellular viability during production compared to the base cellular dairy product. As embodied herein, the adjusted cellular dairy product can be suitable for incorporation into dairy analog products. In addition, or as a further alternative, the adjusted cellular dairy product can have compositional levels of target compounds that reduce compositional gaps compared to the base cellular dairy product.

According to other aspects of the disclosed subject matter, pea protein modification compositions include an enzyme blend including at least one of a transferase, a lyase, a hydrolase, and a phosphatase in a carrier, where the composition is configured to treat pea protein under controlled pH and temperature conditions to produce modified pea protein having reduced presence of at least one off-flavor compound selected from the group consisting of bitter compounds, beany compounds, and astringent compounds, compared to untreated pea protein.

As embodied herein, the transferase can be selected from the group consisting of methyltransferases, aminotransferases, and glycosyltransferases. Additionally or alternatively, the lyase can be selected from the group consisting of sulfur lyases and pectin lyases. Furthermore, or as an alternative, the hydrolase can be selected from the group consisting of beta-glucosidases, beta-fructofuranosidase, alpha-galactosidases, and proteases. Moreover, as embodied herein, the phosphatase can be a phytase.

As embodied herein, the controlled pH conditions can include a pH range of 5.0 to 7.5. Additionally or alternatively, the controlled temperature conditions can include a temperature range of 18° C. to 35° C. Furthermore, or as an alternative, the composition can be configured to treat the pea protein for a duration of 1 to 4 hours. Moreover, as embodied herein, the composition can be configured to increase soluble fiber content in the modified pea protein compared to the untreated pea protein. Additionally or alternatively, the increased soluble fiber content can be about 10% to 50% compared to the untreated pea protein.

As embodied herein, the composition can be configured to reduce the presence of the at least one off-flavor compound by at least 20% compared to the untreated pea protein. In addition, or as a further alternative, the carrier can include an aqueous medium.

According to other aspects of the disclosed subject matter, methods for producing modified pea protein include treating pea protein with an enzyme blend including at least one transferase, lyase, hydrolase, and phosphatase under controlled pH and temperature conditions, where the modified pea protein has reduced presence of at least one off-flavor compound selected from the group consisting of bitter compounds, beany compounds, and astringent compounds, compared to untreated pea protein.

As embodied herein, the transferase can be selected from the group consisting of methyltransferases, aminotransferases, and glycosyltransferases. Additionally or alternatively, the lyase can be selected from the group consisting of sulfur lyases and pectin lyases. Furthermore, or as an alternative, the hydrolase can be selected from the group consisting of beta-glucosidases, beta-fructofuranosidase, alpha-galactosidases, and proteases. Moreover, as embodied herein, the phosphatase can be a phytase.

As embodied herein, the controlled pH conditions can include a pH range of 5.0 to 7.5. Additionally or alternatively, the controlled temperature conditions can include a temperature range of 18° C. to 35° C. Furthermore, or as an alternative, the treating can occur for a duration of 1 to 4 hours. Moreover, as embodied herein, the modified pea protein can have increased soluble fiber content compared to the untreated pea protein. Additionally or alternatively, the increased soluble fiber content can be about 10% to 50% compared to the untreated pea protein.

As embodied herein, the pea protein can include one or more of pea protein isolate or pea protein concentrate. In addition, or as a further alternative, the method can further include spray-drying the modified pea protein to produce a shelf-stable powder.

According to other aspects of the disclosed subject matter, systems for producing modified pea protein include a reaction vessel configured to process pea protein with an enzyme blend, an enzymatic treatment module configured to introduce an enzyme blend including at least one transferase, lyase, hydrolase, and phosphatase, and a drying module configured to stabilize the treated protein into a modified pea protein product.

As embodied herein, the reaction vessel can be configured to maintain controlled pH and temperature conditions during processing. Additionally or alternatively, the controlled pH conditions can include a pH range of 5.0 to 7.5. Furthermore, or as an alternative, the controlled temperature conditions can include a temperature range of 18° C. to 35° C. Moreover, as embodied herein, the drying module can include a spray-drying system. Additionally or alternatively, the enzymatic treatment module can be configured to treat the pea protein for a duration of 1 to 4 hours.

As embodied herein, the transferase can be selected from the group consisting of methyltransferases, aminotransferases, and glycosyltransferases. Additionally or alternatively, the lyase can be selected from the group consisting of sulfur lyases and pectin lyases. Furthermore, or as an alternative, the hydrolase can be selected from the group consisting of beta-glucosidases, beta-fructofuranosidase, alpha-galactosidases, and proteases. Moreover, as embodied herein, the phosphatase can be a phytase.

As embodied herein, the system can be configured to produce modified pea protein having reduced presence of at least one off-flavor compound selected from the group consisting of bitter compounds, beany compounds, and astringent compounds, compared to untreated pea protein. In addition, or as a further alternative, the system can be configured to produce modified pea protein having increased soluble fiber content compared to untreated pea protein.

According to other aspects of the disclosed subject matter, modified pea protein products are provided. In accordance with the disclosed subject matter herein, a modified pea protein product is produced using a pea protein modification composition including an enzyme blend including at least one of a transferase, a lyase, a hydrolase, and a phosphatase in a carrier, where the composition is configured to treat a pea protein under controlled pH and temperature conditions to produce a modified pea protein having reduced presence of at least one off-flavor compound selected from the group consisting of bitter compounds, beany compounds, and astringent compounds, compared to untreated pea protein, where the modified pea protein product has reduced presence of at least one off-flavor compound selected from the group consisting of bitter compounds, beany compounds, and astringent compounds, compared to the unmodified pea protein.

As embodied herein, the modified pea protein product can have increased soluble fiber content compared to the unmodified pea protein. Additionally or alternatively, the increased soluble fiber content can be about 10% to 50% compared to the unmodified pea protein. Furthermore, or as an alternative, the reduced presence of the at least one off-flavor compound can include a reduction of at least 20% compared to the unmodified pea protein. Moreover, as embodied herein, the modified pea protein product can include one or more of a protein powder, protein concentrate, protein isolate, or liquid protein formulation.

As embodied herein, the modified pea protein product can have reduced anti-nutritional factors compared to the unmodified pea protein. Additionally or alternatively, the anti-nutritional factors can include phytic acid. Furthermore, or as an alternative, the modified pea protein product can be suitable for incorporation into plant-based food products. Moreover, as embodied herein, the modified pea protein product can be a shelf-stable powder. Additionally or alternatively, the modified pea protein product can have a neutral flavor profile suitable for custom flavoring applications.

As embodied herein, the modified pea protein product can be suitable for incorporation into plant-based beverages. In addition, or as a further alternative, the modified pea protein product can be selected from the group consisting of pea protein isolate, pea protein concentrate, mung bean protein, and fava bean protein.

According to other aspects of the disclosed subject matter, culture supplement compositions for cellular agriculture protein production include a formulation including, in a carrier, at least one enzyme configured to modify a base cellular agriculture protein product to produce an adjusted cellular agriculture protein product having reduced off-flavor compounds compared to the base cellular agriculture protein product.

As embodied herein, the reduced off-flavor compounds can include reduction of one or more of bitter compounds, beany compounds, astringent compounds, or grassy compounds. Additionally or alternatively, the reduction of bitter compounds can be at least 20% compared to the base cellular agriculture protein product. Furthermore, or as an alternative, the adjusted cellular agriculture protein product can further have increased soluble fiber content compared to the base cellular agriculture protein product. Moreover, as embodied herein, the increased soluble fiber content can be about 10% to 50% compared to the base cellular agriculture protein product.

As embodied herein, the adjusted cellular agriculture protein product can have a neutral flavor profile suitable for ingredient applications. Additionally or alternatively, the at least one enzyme can be selected from the group consisting of transferases, lyases, hydrolases, phosphatases, fatty acid desaturases, cyclooxygenases, lipoxygenases, elongases, oxidoreductases, endopeptidases, exopeptidases, isomerases, and ligases. Furthermore, or as an alternative, the base cellular agriculture protein product can include one or more of precision fermented proteins, plant-based proteins, leguminous proteins, dairy proteins, or cultivated meat proteins.

Moreover, as embodied herein, the formulation can be configured to be added to a cell culture medium at a concentration from 1% v/v to 15% v/v during cellular agriculture protein production. Additionally or alternatively, the carrier can include an emulsifier solution having a concentration from 0.5% v/v to 5% v/v. As embodied herein, the formulation can further include one or more substrates selected from the group consisting of saturated fatty acids, monounsaturated fatty acids, polyunsaturated fatty acids, omega-3 fatty acids, omega-6 fatty acids, peptides, proteins, nucleotides, and amino acids. In addition, or as a further alternative, the composition can be configured to reduce anti-nutritional factors in the adjusted cellular agriculture protein product compared to the base cellular agriculture protein product.

According to other aspects of the disclosed subject matter, methods for producing an adjusted cellular agriculture protein product having reduced off-flavor compounds include providing a base cellular agriculture protein product, adding a culture supplement composition including a formulation including, in a carrier, at least one enzyme to the base cellular agriculture protein product during production, and producing an adjusted cellular agriculture protein product having reduced off-flavor compounds compared to the base cellular agriculture protein product.

As embodied herein, the reduced off-flavor compounds can include reduction of one or more of bitter compounds, beany compounds, astringent compounds, or grassy compounds. Additionally or alternatively, the reduction of bitter compounds can be at least 20% compared to the base cellular agriculture protein product. Furthermore, or as an alternative, adding the culture supplement composition can include adding the composition at a concentration from 1% v/v to 15% v/v to a cell culture medium. Moreover, as embodied herein, the culture supplement composition can be added during at least one of a growth phase, an expression phase, a rehydration phase, or a structuring phase of cellular agriculture protein production.

As embodied herein, the at least one enzyme can be selected from the group consisting of transferases, lyases, hydrolases, phosphatases, fatty acid desaturases, cyclooxygenases, lipoxygenases, elongases, oxidoreductases, endopeptidases, exopeptidases, isomerases, and ligases. Additionally or alternatively, the base cellular agriculture protein product can include one or more of precision fermented proteins, plant-based proteins, leguminous proteins, dairy proteins, or cultivated meat proteins. Furthermore, or as an alternative, the method does not reduce cellular growth or cellular viability compared to production of the base cellular agriculture protein product without the culture supplement composition.

Moreover, as embodied herein, the adjusted cellular agriculture protein product can further have increased soluble fiber content compared to the base cellular agriculture protein product. Additionally or alternatively, the increased soluble fiber content can be about 10% to 50% compared to the base cellular agriculture protein product. As embodied herein, the adjusted cellular agriculture protein product can have a neutral flavor profile suitable for ingredient applications. In addition, or as a further alternative, the method can reduce anti-nutritional factors in the adjusted cellular agriculture protein product compared to the base cellular agriculture protein product.

According to other aspects of the disclosed subject matter, systems for producing adjusted cellular agriculture protein products having reduced off-flavor compounds include a reaction vessel configured to process a base cellular agriculture protein product with a culture supplement composition, and processing circuitry configured to introduce the culture supplement composition including a formulation including, in a carrier, at least one enzyme, and control production of the adjusted cellular agriculture protein product having reduced off-flavor compounds compared to the base cellular agriculture protein product.

As embodied herein, the reduced off-flavor compounds can include reduction of one or more of bitter compounds, beany compounds, astringent compounds, or grassy compounds. Additionally or alternatively, the reduction of bitter compounds can be at least 20% compared to the base cellular agriculture protein product. Furthermore, or as an alternative, the processing circuitry can be configured to add the culture supplement composition at a concentration from 1% v/v to 15% v/v to a cell culture medium. Moreover, as embodied herein, the processing circuitry can be configured to add the culture supplement composition during at least one of a growth phase, an expression phase, a rehydration phase, or a structuring phase of cellular agriculture protein production.

As embodied herein, the at least one enzyme can be selected from the group consisting of transferases, lyases, hydrolases, phosphatases, fatty acid desaturases, cyclooxygenases, lipoxygenases, elongases, oxidoreductases, endopeptidases, exopeptidases, isomerases, and ligases. Additionally or alternatively, the base cellular agriculture protein product can include one or more of precision fermented proteins, plant-based proteins, leguminous proteins, dairy proteins, or cultivated meat proteins. Furthermore, or as an alternative, the system can be configured to produce the adjusted cellular agriculture protein product without reducing cellular growth or cellular viability compared to the base cellular agriculture protein product without the culture supplement composition.

Moreover, as embodied herein, the system can be configured to produce the adjusted cellular agriculture protein product having increased soluble fiber content compared to the base cellular agriculture protein product. Additionally or alternatively, the increased soluble fiber content can be about 10% to 50% compared to the base cellular agriculture protein product. As embodied herein, the system can be configured to produce the adjusted cellular agriculture protein product having a neutral flavor profile suitable for ingredient applications. In addition, or as a further alternative, the system can be configured to reduce anti-nutritional factors in the adjusted cellular agriculture protein product compared to the base cellular agriculture protein product.

According to other aspects of the disclosed subject matter, adjusted cellular agriculture protein products having reduced off-flavor compounds are provided. In accordance with the disclosed subject matter herein, an adjusted cellular agriculture protein product having reduced off-flavor compounds is produced using a culture supplement composition including a formulation including, in a carrier, at least one enzyme configured to modify a base cellular agriculture protein product to produce an adjusted cellular agriculture protein product having reduced off-flavor compounds compared to the base cellular agriculture protein product, where the adjusted cellular agriculture protein product has reduced off-flavor compounds compared to the base cellular agriculture protein product.

As embodied herein, the reduced off-flavor compounds can include reduction of one or more of bitter compounds, beany compounds, astringent compounds, or grassy compounds. Additionally or alternatively, the reduction of bitter compounds can be at least 20% compared to the base cellular agriculture protein product. Furthermore, or as an alternative, the adjusted cellular agriculture protein product can further have increased soluble fiber content compared to the base cellular agriculture protein product. Moreover, as embodied herein, the increased soluble fiber content can be about 10% to 50% compared to the base cellular agriculture protein product.

As embodied herein, the adjusted cellular agriculture protein product can have a neutral flavor profile. Additionally or alternatively, the neutral flavor profile of the product can be suitable for use as an ingredient base for incorporation into end products made using custom flavoring. Furthermore, or as an alternative, the neutral flavor profile can provide reduced or minimized flavor interference with flavor additives added to the adjusted cellular agriculture protein product compared to the base cellular agriculture protein product.

Moreover, as embodied herein, the cellular agriculture protein product can include one or more of precision fermented proteins, plant-based proteins, leguminous proteins, dairy proteins, or cultivated meat proteins. Additionally or alternatively, the adjusted cellular agriculture protein product can be selected from the group consisting of protein powders, protein concentrates, protein isolates, liquid protein formulations, and spray-dried protein ingredients. As embodied herein, the adjusted cellular agriculture protein product can have reduced anti-nutritional factors compared to the base cellular agriculture protein product. In addition, or as a further alternative, the adjusted cellular agriculture protein product can be produced without reducing cellular growth or cellular viability during production compared to the base cellular agriculture protein product.

According to other aspects of the disclosed subject matter, culture supplement compositions for producing an adjusted cellular protein product having reduced off-flavor compounds include a formulation including, in a carrier, at least one enzyme configured to modify a base cellular protein product to produce an adjusted cellular protein product having reduced off-flavor compounds compared to the base cellular protein product.

As embodied herein, the reduced off-flavor compounds can be selected from the group consisting of bitter compounds, beany compounds, astringent compounds, and grassy compounds. Additionally or alternatively, the reduction of off-flavor compounds can include a reduction of at least 20% compared to the base cellular protein product. Furthermore, or as an alternative, the adjusted cellular protein product can include a pea protein product. Moreover, as embodied herein, the adjusted cellular protein product can further have increased soluble fiber content compared to the base cellular protein product. Additionally or alternatively, the increased soluble fiber content can be about 10% to 50% compared to the base cellular protein product.

As embodied herein, the adjusted cellular protein product can have a neutral flavor profile suitable for ingredient applications. Additionally or alternatively, the at least one enzyme can be selected from the group consisting of transferases, lyases, hydrolases, phosphatases, fatty acid desaturases, cyclooxygenases, lipoxygenases, elongases, oxidoreductases, endopeptidases, exopeptidases, isomerases, and ligases. Furthermore, or as an alternative, the at least one enzyme can include an enzyme blend including at least one of a transferase, a lyase, a hydrolase, and a phosphatase.

Moreover, as embodied herein, the transferase can be selected from the group consisting of methyltransferases, aminotransferases, and glycosyltransferases. Additionally or alternatively, the lyase can be selected from the group consisting of sulfur lyases and pectin lyases. As embodied herein, the hydrolase can be selected from the group consisting of beta-glucosidases, beta-fructofuranosidase, alpha-galactosidases, and proteases. In addition, or as a further alternative, the phosphatase can be a phytase.

Furthermore, or as an alternative, the base cellular protein product can include one or more of precision fermented proteins, plant-based proteins, leguminous proteins, dairy proteins, or cultivated meat proteins. Moreover, as embodied herein, the formulation can be configured to be added to a cell culture medium at a concentration from 1% v/v to 15% v/v during cellular protein production. Additionally or alternatively, the carrier can include an emulsifier solution having a concentration from 0.5% v/v to 5% v/V.

As embodied herein, the formulation can further include one or more substrates selected from the group consisting of saturated fatty acids, monounsaturated fatty acids, polyunsaturated fatty acids, omega-3 fatty acids, omega-6 fatty acids, peptides, proteins, nucleotides, and amino acids. Additionally or alternatively, the composition can be configured to reduce anti-nutritional factors in the adjusted cellular protein product compared to the base cellular protein product. Furthermore, or as an alternative, the composition can be configured to treat the base cellular protein product under controlled pH conditions including a pH range of 5.0 to 7.5 and controlled temperature conditions including a temperature range of 18° C. to 35° C.

According to other aspects of the disclosed subject matter, adjusted cellular agriculture protein products having reduced off-flavor compounds are provided. In accordance with the disclosed subject matter herein, an adjusted cellular agriculture protein product having reduced off-flavor compounds is produced using a culture supplement composition including a formulation including, in a carrier, at least one enzyme configured to modify a base cellular agriculture protein product to produce an adjusted cellular agriculture protein product having reduced off-flavor compounds compared to the base cellular agriculture protein product, where the adjusted cellular agriculture protein product has reduced off-flavor compounds compared to the base cellular agriculture protein product.

It is to be understood that both the foregoing general description and the following detailed description are exemplary and are intended to provide further explanation of the disclosed subject matter.

The accompanying drawings, which are incorporated in and constitute part of this specification, are included to illustrate and provide a further understanding of the methods, systems and compositions of the disclosed subject matter. Together with the description, the drawings explain the principles of the disclosed subject matter.

### BRIEF DESCRIPTION OF THE DRAWINGS

The details of the subject matter set forth herein, both as to its structure and operation, may be apparent by study of the accompanying figures, in which like reference numerals refer to like parts.

FIG. 1 is a diagram illustrating an exemplary system for cellular attribute alignment of a base cellular agriculture product with a reference product in accordance with the disclosed subject matter.

FIG. 2 is a diagram illustrating an exemplary technique for cellular attribute alignment of a base cellular agriculture product with a reference product in accordance with the disclosed subject matter.

FIG. 3 is a diagram illustrating an exemplary embodiment of a manufacturing process for a cellular agriculture product in accordance with the disclosed subject matter.

FIGS. 4A-4C each is a diagram illustrating an alternative embodiment of a manufacturing process for a cellular agriculture product in accordance with the disclosed subject matter.

FIG. 5 is a diagram illustrating an exemplary embodiment of a culture supplement composition for a cellular agriculture product in accordance with the disclosed subject matter.

FIGS. 6A and 6B each is a diagram illustrating an exemplary embodiment of a targeted enzyme pathway of a reference product for production of a cellular agriculture product in accordance with the disclosed subject matter.

FIGS. 7A and 7B each is a graph illustrating exemplary embodiments of compositional profiles obtained from an electronic nose of a reference product, base cellular agriculture products, and adjusted cellular agriculture products, shown side-by-side for purpose of illustration and comparison.

FIG. 8A is a graph illustrating additional details of compositional profiles of the reference product and base cellular agriculture products of FIGS. 7A and 7B in accordance with the disclosed subject matter.

FIG. 8B is a graph illustrating additional details of compositional profiles of the reference product, base cellular agriculture products, and adjusted cellular agriculture products of FIGS. 7A and 7B in accordance with the disclosed subject matter.

FIG. 9 is a graph illustrating additional details of the compositional profiles of the reference product, base cellular agriculture products and an adjusted cellular agriculture product of FIG. 7A.

FIG. 10A is a graph illustrating additional details of compositional profiles of the reference product and base cellular agriculture products of FIGS. 7A and 7B in accordance with the disclosed subject matter.

FIG. 10B is a graph illustrating additional details of compositional profiles of the reference product, base cellular agriculture products, and adjusted cellular agriculture products of FIGS. 7A and 7B in accordance with the disclosed subject matter.

FIGS. 11A-11C each is a graph illustrating additional details of compositional profiles of the reference product, base cellular agriculture products, and adjusted cellular agriculture products of FIGS. 7A and 7B in accordance with the disclosed subject matter.

FIG. 12 is a graph illustrating exemplary embodiments of flavor profiles of a base cellular agriculture product and adjusted cellular agriculture products in accordance with the disclosed subject matter.

FIG. 13 is a graph illustrating additional details of compositional profiles of the base cellular agriculture product and the adjusted cellular agriculture products of FIG. 12.

FIG. 14 is a graph illustrating additional details of flavor profiles of a base cellular agriculture product and an adjusted cellular agriculture product in accordance with the disclosed subject matter.

FIG. 15 is a graph illustrating additional details of compositional profiles of the base cellular agriculture product and the adjusted cellular agriculture product of FIG. 14, together on a common horizontal axis for purpose of comparison.

### DETAILED DESCRIPTION

Reference will now be made in detail to the various aspects of the disclosed subject matter, exemplary embodiments of which are illustrated in the accompanying drawings. The structure and corresponding method of operation of the disclosed subject matter will be described in conjunction with the detailed description of the system.

The systems, methods and compositions presented herein may be used for production of cellular agriculture protein products, and are particularly suited for providing adjusted cellular agriculture protein products having one or more improved attributes compared to base cellular agriculture protein products. The systems, methods and compositions presented herein can adjust protein substrates to achieve desired sensory, functional, and nutritional outcomes through targeted molecular modification approaches. For example and without limitation, as embodied herein, such molecular modifications can include enhanced alignment with traditional protein product characteristics, neutral flavor profiles with reduced or substantially eliminated off-flavor compounds suitable for ingredient applications, or combinations thereof. The enzymatic modification approaches can be tailored to achieve specific sensory, nutritional, and functional outcomes, including for direct consumer applications, ingredient manufacturing applications, or integrated approaches that provide versatility across multiple commercial uses. Such systems, methods and compositions can maintain production efficiency while providing a relatively clean ingredient label compared to conventional techniques for cellular agriculture protein products, including additive or post-processing techniques.

The systems, methods and compositions disclosed herein can be configured to achieve molecular modification of cellular agriculture protein products through targeted enzymatic approaches. For example and without limitation, as embodied herein, such molecular modifications can include enhanced alignment with traditional protein product characteristics, neutral flavor profiles with reduced or substantially eliminated off-flavor compounds suitable for ingredient applications, or combinations thereof. The enzymatic modification approaches can be tailored to achieve specific sensory, nutritional, and functional outcomes, including for direct consumer applications, ingredient manufacturing applications, or integrated approaches that provide versatility across a variety of commercial uses.

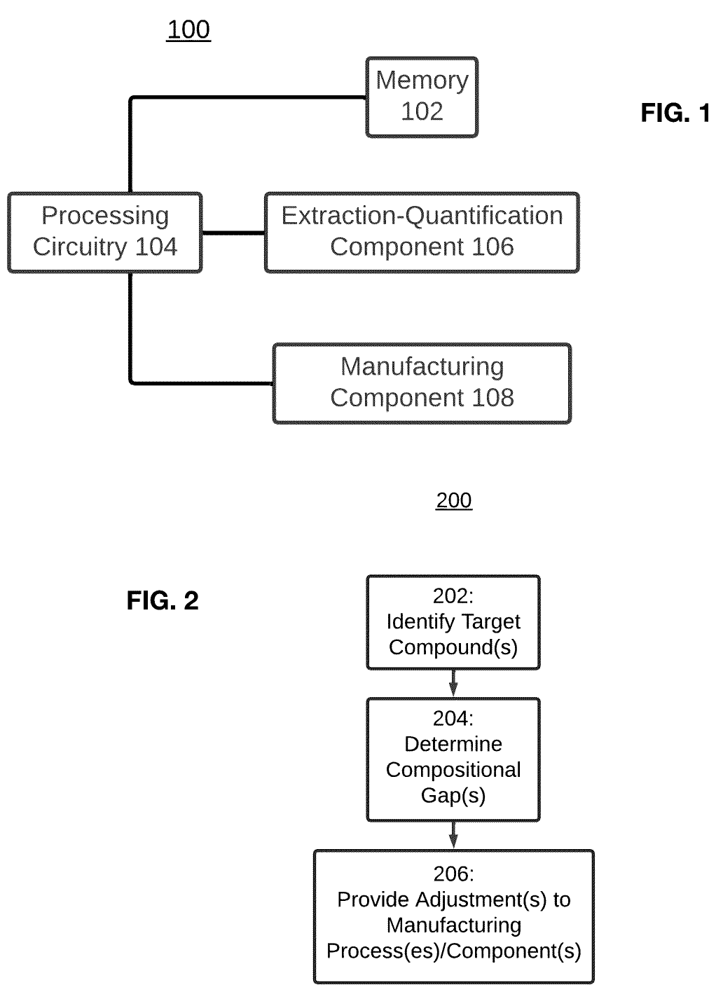

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, exemplary embodiments of systems, methods and related compositions for production of cellular agriculture protein products in accordance with the disclosed subject matter are shown in FIGS. 1-15. The systems, methods and compositions presented herein can also include the features of and be used, for example and not limitation, with systems, methods and compositions for attribute alignment of a base cellular agriculture product with a reference product illustrated and described in U.S. Patent Application Publication No. 2024/0294868, which is incorporated by reference herein in its entirety. The systems, methods, and compositions described herein are suitable for producing cellular agriculture protein products having attributes that more closely align with consumer preferences, which can include desirable attributes of comparable traditional protein products, as well as neutral or blank flavor profiles that serve as versatile ingredient bases for end-product manufacturers. Such cellular agriculture protein products can be produced having desired attributes or reduced or substantially eliminated unwanted attributes during the production or processing phase. Such cellular agriculture protein products can thus be used as direct consumer products with enhanced sensory characteristics, or as ingredient bases for incorporation into end products where manufacturers desire complete control over final flavor profiles.

Cellular agriculture protein products described herein are suitable for a variety of uses, including without limitation as food products such as dairy proteins (e.g., casein, whey proteins, and substitutes for these), plant-based proteins (e.g., leguminous proteins including pea protein, mung bean protein, fava bean protein, and substitutes for these), cultivated meat proteins, precision fermented proteins, and other protein-containing food products. Additionally, such products are suitable for ingredient applications including protein beverage bases, nutritional supplement components, plant-based meat analog ingredients, and other commercial applications where neutral flavor characteristics enable custom flavoring and formulation flexibility. Cellular agriculture protein products described herein can be produced various ways, including and without limitation by precision fermentation (for example, by engineered microorganisms producing proteins in a bioreactor), cultivation (for example, by growing cells for protein biomass in a bioreactor), and plant-based processing (for example, by processing plant proteins to enhance functional and sensory properties for cellular agriculture applications).

Cellular agriculture protein products described herein can have improved attributes compared to base cellular agriculture protein products. Such attributes can include attributes affected by the molecular composition of the protein product, which can include flavor, nutrition, digestibility, solubility, texture, and functional properties of the cellular agriculture protein product. The disclosed systems, methods, and compositions can thus modify molecular components responsible for undesirable sensory or nutritional characteristics while preserving or enhancing beneficial protein properties. Such modifications can be targeted toward achieving alignment with traditional product characteristics or toward substantially eliminating off-flavor compounds to achieve neutral sensory profiles.

For example and without limitation, systems, methods, and compositions disclosed herein are particularly suitable and beneficial for producing enhanced dairy protein products with improved flavor profiles that more closely resemble traditional dairy products, enhanced leguminous protein products with reduced off-flavors, improved digestibility, and increased soluble fiber content, and neutral flavor profile protein products with reduced or substantially eliminated bitter, beany, astringent, or other undesirable sensory characteristics suitable for ingredient applications. The disclosed subject matter provides approaches for molecular-level modification of protein substrates to achieve targeted improvements in one or more attributes, including for example and without limitation, sensory attributes that align with consumer preferences for traditional products, sensory neutrality that enables ingredient versatility, nutritional profile enhancement, and functional characteristics suitable for various cellular agriculture applications.

In accordance with the disclosed subject matter herein, culture supplement compositions for cellular agriculture protein production include a formulation including, in a carrier, at least one enzyme configured to modify a base cellular agriculture protein product to produce an adjusted cellular agriculture protein product having reduced off-flavor compounds compared to the base cellular agriculture protein product.

According to other aspects of the disclosed subject matter, culture supplement compositions for producing an adjusted cellular protein product having reduced off-flavor compounds include a formulation including, in a carrier, at least one enzyme configured to modify a base cellular protein product to produce an adjusted cellular protein product having reduced off-flavor compounds compared to the base cellular protein product.

According to other aspects of the disclosed subject matter, adjusted cellular agriculture protein products having reduced off-flavor compounds are provided. In accordance with the disclosed subject matter herein, an adjusted cellular agriculture protein product having reduced off-flavor compounds is produced using a culture supplement composition including a formulation including, in a carrier, at least one enzyme configured to modify a base cellular agriculture protein product to produce an adjusted cellular agriculture protein product having reduced off-flavor compounds compared to the base cellular agriculture protein product, where the adjusted cellular agriculture protein product has reduced off-flavor compounds compared to the base cellular agriculture protein product.

According to other aspects of the disclosed subject matter, methods for producing an adjusted cellular agriculture protein product having reduced off-flavor compounds include providing a base cellular agriculture protein product, adding a culture supplement composition including a formulation including, in a carrier, at least one enzyme to the base cellular agriculture protein product during production, and producing an adjusted cellular agriculture protein product having reduced off-flavor compounds compared to the base cellular agriculture protein product.

According to other aspects of the disclosed subject matter, systems for producing adjusted cellular agriculture protein products are provided having reduced off-flavor compounds include a reaction vessel configured to process a base cellular agriculture protein product with a culture supplement composition, and processing circuitry configured to introduce the culture supplement composition including a formulation including, in a carrier, at least one enzyme, and control production of the adjusted cellular agriculture protein product having reduced off-flavor compounds compared to the base cellular agriculture protein product.

According to other aspects of the disclosed subject matter, adjusted cellular agriculture protein products having reduced off-flavor compounds are provided. In accordance with the disclosed subject matter herein, an adjusted cellular agriculture protein product having reduced off-flavor compounds is produced using a culture supplement composition including a formulation including, in a carrier, at least one enzyme configured to modify a base cellular agriculture protein product to produce an adjusted cellular agriculture protein product having reduced off-flavor compounds compared to the base cellular agriculture protein product, where the adjusted cellular agriculture protein product has reduced off-flavor compounds compared to the base cellular agriculture protein product.

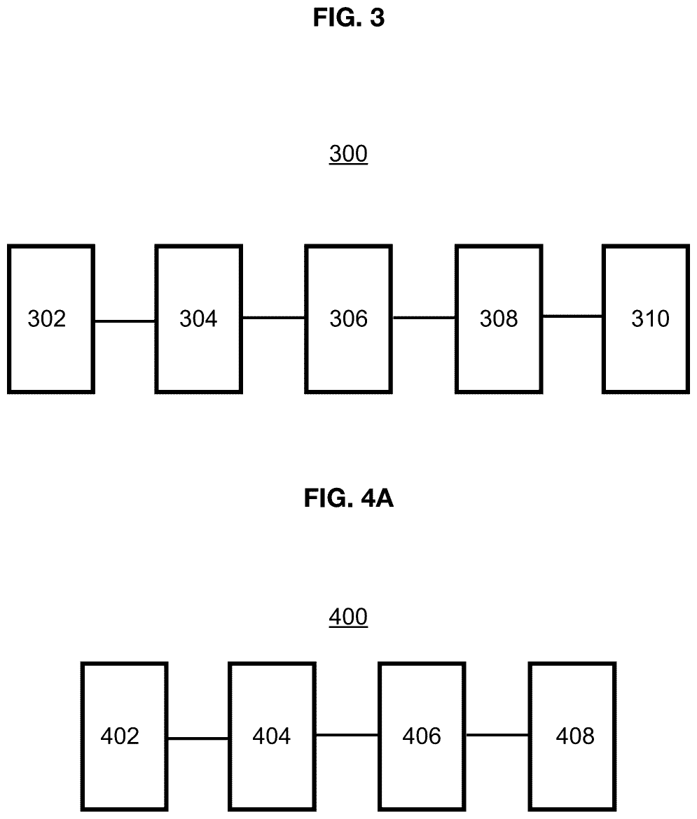

For purpose of illustration, and not limitation, reference is made to the exemplary embodiments of systems and methods for cellular attribute alignment of a base cellular agriculture product with a reference product shown in FIGS. 1 and 2. As shown for example and without limitation in FIGS. 1 and 2, as embodied herein, a system 100 of FIG. 1 can be configured to perform method 200, for cellular attribute alignment of a base cellular agriculture product with a reference product.

For example and not limitation, as embodied herein, the base cellular agriculture product can include any cellular agriculture product described herein, including but not limited to, a cultivated food, a precision fermented food, a cultivated material product, another agricultural product produced from a cell culture, a plant-based cellular agriculture product, or a plant-based food substitute product (e.g., meat or dairy substitute). As embodied herein, the base cellular agriculture product can include a cellular agriculture protein product as described herein, including but not limited to, precision fermented proteins (e.g., dairy proteins such as casein and whey proteins), plant-based proteins (e.g., leguminous proteins such as pea protein, mung bean protein, and fava bean protein), cultivated meat proteins, or other protein products produced from cell cultures.

For purpose of illustration and not limitation, as embodied herein, the reference product can include any naturally-occurring or traditionally-produced product of interest to be emulated by a cellular agriculture product. For example and without limitation, the reference product can include an animal or plant-based food product, an animal or plant-based material product, or another naturally-occurring or traditionally-produced agricultural product. As embodied herein, the reference product can include traditional protein products, including but not limited to animal-based dairy proteins such as from cow and goat milks, traditional plant proteins, or other naturally-occurring or traditionally-produced protein products having desired sensory, functional, or nutritional characteristics. As embodied herein, the reference product can include traditional protein-based products, for example and without limitation, dairy products (such as cow's milk, cheese, and yogurt), meat products (such as ground beef, chicken breast, and processed meats), egg products (such as scrambled eggs and egg whites), seafood products (such as white fish fillets and shellfish), protein supplements (such as whey protein powder and protein bars), and traditional plant proteins (such as tofu and tempeh), and products made from or substitutes for such traditional protein-based products.

Each of the base cellular agriculture product and the reference product can have one or more cellular attributes of interest. For purpose of illustration and not limitation, as embodied herein, attributes of interest of the base cellular agriculture protein products and reference protein products described herein can include flavors or flavor profiles, nutritional components (including for example digestibility and soluble fiber content), functional properties (including for example solubility and texture), or any other protein attribute of interest affected by the molecular components of the protein product as described herein.

With reference to FIG. 1, as embodied herein, system 100 for cellular attribute alignment of a base cellular agriculture product with a reference product can include a memory 102 and a processing circuitry 104. As shown in FIG. 1, system 100 can further include an extraction-quantification component 106 in communication with processing circuitry 104. Additionally or alternatively, as embodied herein, system 100 can further include, or communicate with, a manufacturing component 108.

As embodied herein, memory 102 can include storage space for data or instructions accessible to processing circuitry 104. For example and without limitation, memory 102 can include one or more memories on a local device, including but not limited to random-access memory (RAM), read-only memory (ROM), flash memory, cache memory, secondary storage memory (e.g., hard disk drive (HDD) or solid-state drive (SSD)), or can be distributed across a plurality of devices, such as one or more cloud storage devices or other remote storage devices accessible over a network.

Moreover, as embodied herein, memory 102 can store, for example, first data including a compositional profile of a reference product having a cellular attribute of interest, and second data including a compositional profile of a base cellular agriculture product produced to emulate the cellular attribute of interest of the reference product. Additionally or alternatively, as embodied herein, memory 102 can include a plurality of sets of first data including compositional profiles of a plurality of reference products having one or more cellular attributes of interest, and a plurality of sets of second data including compositional profiles of a plurality of base cellular agriculture products produced to emulate the one or more cellular attributes of interest. Furthermore, as embodied herein, memory 102 can store compositional profiles of reference products, target molecular profiles for specific applications, and neutral flavor profile standards, which can be used by processing circuitry 104 to implement a variety of molecular modification approaches including, for example and without limitation, reference product alignment, neutral sensory characteristic achievement, or combinations thereof suitable for various commercial applications as described herein.

Further, as embodied herein, memory 102 can store compositional profiles and other data, including for example and without limitation, data that can be used by processing circuitry 104 to identify one or more cellular attributes of interest. As embodied herein, data stored by memory 102 can include information identifying particular molecular components affecting the one or more cellular attributes of interest as described herein. Memory 102 can further include compositional profiles and other data obtained from third-party databases or research, including publicly-available databases or research, prior samples and analysis of cellular agriculture products compared to reference products, data obtained from external devices and sensors, including but not limited to electronic tongues or electronic noses, data obtained from flavor panels, and data relating consumer preferences to reference products or to attributes of interest.

For purpose of illustration only, and not limitation, the cellular agriculture products and reference products can be food products, and the cellular attributes of interest can be related to flavor, nutrition, texture or color of the food products. As embodied herein, using flavor as an example, the compositional profiles of the base cellular agriculture product and the reference product each can include a measurement of one or more molecular flavor components, including but not limited to free fatty acids, nucleotides (including ribonucelotides), kokumi or umami peptides.

Additionally or alternatively, as embodied herein, the compositional profiles can include measurements or data obtained from cellular agriculture products or reference products using various forms of spectroscopic analysis, such as nuclear magnetic resonance (NMR) spectroscopy, infrared (IR) spectroscopy, or mass spectrometry. The resulting data can provide detailed information about the molecular structure and composition of the cellular agriculture products and reference products. Moreover, or as an alternative, the compositional profiles from such analyses can be stored in one or more records or databases in memory 102. In addition, or as a further alternative, the compositional profiles can be obtained using extraction-quantification component 106, as described herein.

Referring still to FIG. 1, processing circuitry 104 can include one or more processors configured to perform data processing and control functions described herein. For example and without limitation, processing circuitry 104 can be configured to implement any of the methods and interact with any of the systems or components shown or described herein and with respect to FIGS. 2-13. Processing circuitry 104 can include local processing circuitry, such as one or more processors disposed entirely on a mobile device, computer workstation, or laboratory instrument, or remote processing circuitry, such as a remote processor in a smartphone, smart glasses, smart watch, or other remote device, or any combination thereof. Other suitable configurations of processing circuitry 104 are envisioned. As an example, processing circuitry 104 of system 100 can include or be implemented as a special-purpose processor, such as an application-specific integrated circuit (ASIC) or a field programmable gate array (FPGA). As embodied herein, processing circuitry 104 can include a general-purpose processing unit (e.g., a central processing unit (CPU)), or can include another programmable processor that is temporarily configured by software to execute the functions of system 100. More generally, processing circuitry 104 can be implemented using hardware, firmware, software, or a suitable combination of hardware, firmware, and software.

Additionally or alternatively, as embodied herein, processing circuitry 104 can be configured to implement molecular modification approaches through enzymatic treatments, including for example and without limitation, compositional gap reduction for reference product alignment, substantial elimination of off-flavor compounds for neutral profiles, or integrated approaches that achieve multiple objectives in combination. Such molecular modifications can be targeted toward consumer applications, ingredient applications, or versatile formulations suitable for a variety of end-use requirements. Processing circuitry 104 can be configured to analyze compositional profiles and determine culture supplement compositions 1000 and manufacturing parameters to achieve targeted outcomes including reference product characteristics, neutral sensory profiles, enhanced functionality, or combinations thereof, providing manufacturing flexibility for a variety of commercial applications.

Processing circuitry 104 can further include a user interface to provide feedback and information, such as reports, to a user and allow for selection of operation of system 100, for example and without limitation, to control or adjust operation of system 100, including extraction-quantification component 106 or manufacturing component 108, each if provided or in communication with system 100. The user interface can include, for example and without limitation, a touch-screen display, microphone, or other input device, which can be disposed entirely on system 100, or can be entirely or at least partially remote, such as by using a touch-screen display, microphone or other input device of the smartphone, smart glasses, smart watch, or other remote device for example when used as a remote component of processing circuitry 104.

Referring still to FIG. 1, additionally or alternatively, system 100 can further include, or communicate with using processing circuitry 104, one or more extraction-quantification components 106 configured to extract and quantify analytical samples of cellular agriculture products and reference products, as shown and described herein. For purpose of illustration and not limitation, as embodied herein, extraction-quantification component 106, if provided, can include a chromatographic and/or a spectroscopic analyzer, such as one or more of a gas chromatograph, a mass spectrometer, and a liquid chromatograph, as part of or in communication with system 100. Extraction-quantification component 106 can include any additional features described herein and in U.S. Patent Application Publication No. 2024/0294868, which is incorporated by reference herein in its entirety.

Furthermore, as embodied herein, extraction-quantification component 106 can be configured to analyze compositional profiles for molecular modification verification across a variety of applications. For example and without limitation, as embodied herein, the analytical capabilities can include reference product alignment assessment, neutral flavor profile verification, nutritional enhancement quantification, functional property evaluation, or combinations thereof, which can be used by processing circuitry 104 to improve enzymatic treatments to provide products having desired commercial features according to the disclosed subject matter. The extraction-quantification component 106 can generate compositional profile data to support implementation of molecular modification approaches tailored to achieve targeted product features for consumer applications, ingredient applications, or versatile formulations suitable for a variety of end-use requirements.

With configured reference to FIG. 1, furthermore, or as an alternative, system 100 can further include, or communicate with using processing circuitry 104, one or more manufacturing components 108 for producing cellular agriculture products. For purpose of illustration and not limitation, as embodied herein, manufacturing component 108 can include a bioreactor to grow or express cells used for cellular agriculture products. Manufacturing component 108 can include any additional features described herein, including without limitation as shown and described with respect to FIGS. 2-4C.

Moreover, as embodied herein, manufacturing component 108 can be configured to implement molecular modification approaches through controlled enzymatic treatments. For example and without limitation, as embodied herein, the manufacturing processes can be improved to achieve reference product characteristics, neutral sensory profiles, enhanced nutritional properties, improved functional attributes, or combinations thereof, providing production flexibility for consumer applications, ingredient manufacturing, or integrated commercial strategies. Manufacturing component 108 can be configured to integrate culture supplement compositions 1000 during various production phases to achieve targeted molecular modifications while maintaining cellular viability and production efficiency across a variety of commercial applications.

Referring now to FIG. 2, as embodied herein, system 100 can be configured to perform method 200 for cellular attribute alignment of a base cellular agriculture product with a reference product. For purpose of illustration and not limitation, as embodied herein, at 202, processing circuitry 104 can be configured to identify, using the first data in memory 102, one or more target compounds affecting the attribute of interest, which can include compounds for reference product alignment, off-flavor compounds for elimination to achieve neutral profiles, or combinations thereof to provide molecular modification approaches suitable for a variety of commercial applications as described herein. The one or more target compounds can be identified, for example, by examination of compositional profiles of one or more reference products having the attribute of interest, neutral flavor profile standards, or integrated targets for multiple commercial applications. The one or more reference products or target profiles can be identified from a variety of data sources, for example and without limitation, by third-party databases or research, data obtained from flavor panels, neutral flavor profile specifications for ingredient applications, and data connecting consumer preferences to attributes of interest.

As embodied herein, the compositional profiles of the one or more identified reference products or target profiles can be examined, for example and without limitation, by comparing one or more identified compounds in the reference product to a threshold, or by identifying off-flavor compounds for substantial elimination to achieve neutral sensory characteristics. For example, as embodied herein, one or more identified compounds in the reference product exceeding a size or a volume threshold determined from the compositional profile data can be identified as affecting the attribute of interest in the reference product, or compounds contributing to undesirable sensory characteristics can be identified for elimination to achieve neutral flavor profiles suitable for ingredient applications.

Referring still to FIG. 2, as embodied herein, at 204, processing circuitry 104 can be configured to determine at least one compositional gap in the base cellular agriculture product compared to the reference product by comparison of compositional levels of the one or more target compounds in the first data to corresponding compositional levels of the one or more target compounds in the second data. For purpose of illustration and not limitation, as embodied herein, the first data and second data obtained as described herein can be analyzed to identify differences in the compositional levels of the target compounds between the base cellular agriculture product and the reference product. Such analysis can involve, for example and without limitation, comparing chemical shifts in NMR spectra, absorption bands in IR spectra, or mass-to-charge ratios in mass spectrometry data.

With continued reference to FIG. 2, as embodied herein, at 206, processing circuitry 104 can be configured to provide an adjustment to a manufacturing process or a manufacturing component 108 for the base cellular agriculture product. The adjustment can implement molecular modification approaches to produce an adjusted cellular agriculture product having targeted characteristics. For example and without limitation, as embodied herein, such molecular modifications can include compositional gap reduction for reference product alignment, substantial elimination of off-flavor compounds for neutral sensory profiles, enhanced nutritional characteristics, improved functional properties, or combinations thereof. The molecular modification approaches can be tailored to achieve desired commercial features including for consumer applications, ingredient applications, or integrated formulations suitable for multiple end-use requirements.

As embodied herein, the adjustment to the manufacturing process or the manufacturing component can be configured such that the adjustment does not reduce or inhibit cellular growth or cellular viability of the adjusted cellular agriculture product compared to the base cellular agriculture product. For example and not limitation, the adjustment to the manufacturing process or the manufacturing component can be configured to modify a growth phase or an expression phase of the base cellular agriculture product, as embodied herein, in a bioreactor.

Additionally or alternatively, as embodied herein, processing circuitry 104 can be configured to provide the adjustment by formulating a target product to measure alignment or quality control of the adjusted cellular agriculture product compared to the reference product or to a target reference standard. That is, the target product can be formulated by the processing circuitry 104 to provide a quality control target or reference standard for the adjusted cellular agriculture product derived from reducing or eliminating the at least one compositional gap of the base cellular agriculture product determined in 204. The target product can thus be used to adjust a manufacturing process or manufacturing component 108 of the base cellular agriculture product to obtain the target product representing the adjusted cellular agriculture product having increased alignment with the attribute of interest of the reference product or the target reference standard. Moreover, processing circuitry 104 can be further configured to control operation of a manufacturing component, such as a mixer, to combine the formulation components to produce the formulated target product. For example and without limitation, as embodied herein, each component identified as relevant to an attribute of interest can be mixed by the mixer at a specified concentration and dissolved in a solvent to create a standard used for instrument calibration and compared to a library of known compounds (e.g., from MassHunter software by Agilent).

Furthermore, or as an alternative, as embodied herein, processing circuitry 104 can be configured to provide the adjustment to the manufacturing process or the manufacturing component by formulating a culture supplement composition used to produce cells of the adjusted cellular agriculture product. That is, the culture supplement composition, which can include for purpose of illustration and not limitation any features of culture supplement composition 1000 described further herein, can be added during manufacture of the base cellular agriculture product, for example and without limitation during at least one of a growth phase, an expression phase, a rehydration phase, or a structuring phase of the base cellular agriculture product. As embodied herein, the culture supplement composition can be added to growth media of the base cellular agriculture product. For example and not limitation, manufacturing component 108 can include a production vessel, such as a bioreactor, a shake flask, or other vessel suitable for biomass production, and a mixer. As embodied herein, processing circuitry 104 can be further configured to control operation of at least one of the production vessel or the mixer, to produce the formulated culture supplement composition or apply the culture supplement composition to the cell culture in the production vessel.

An adjusted cellular agriculture product can thus be formed having an increased alignment of the attribute of interest with the reference product. As such, the reference product can be selected to be used as a proxy for alignment with consumer preferences, and the adjusted cellular agriculture product can thus have increased alignment of the attribute of interest with consumer preferences in the market.

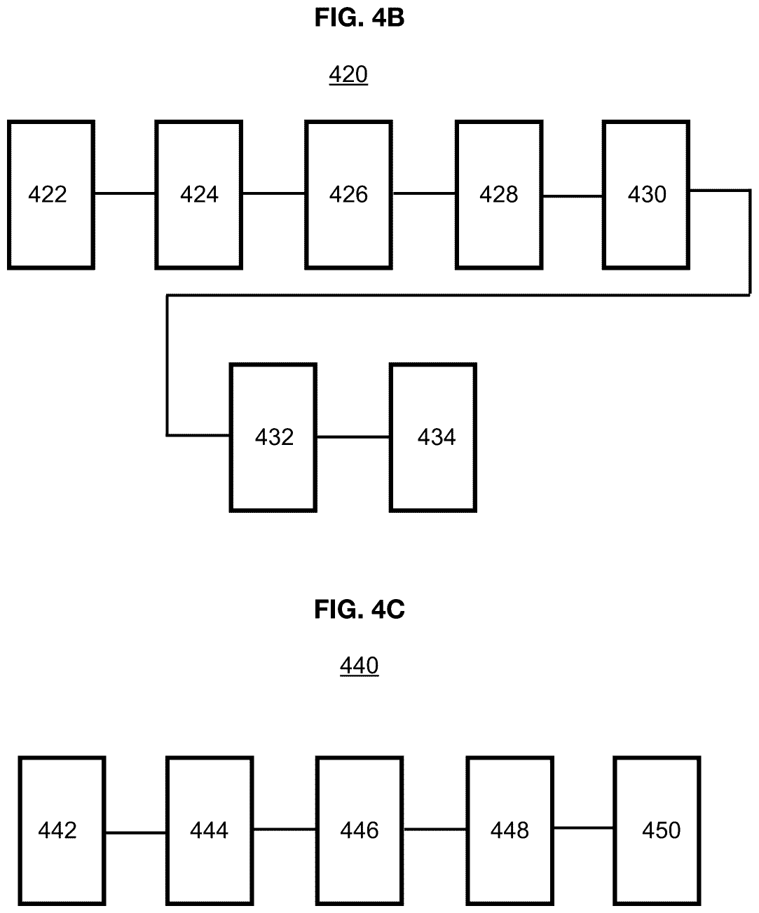

Additional details and examples of system 100 and method 200 for producing an adjusted cellular agriculture product are shown and described, for purpose of illustration and confirmation of the disclosed subject matter and not limitation, with reference to the exemplary embodiments of FIGS. 3-13.

Referring now to FIG. 3, an exemplary manufacturing process for a cellular agriculture product is shown. As shown in FIG. 3, for purpose of illustration and not limitation, manufacturing process 300 for a cellular agriculture product can include cell development at 302, growth or expression (e.g., in a bioreactor) at 304, harvest and processing at 306, structuring at 308, and packaging at 310. As embodied herein, system 100 and method 200 can adjust the manufacturing process during the growth or expression phase of the cellular agriculture product manufacturing process as described herein to affect attributes of interest, including but not limited to flavor. Such molecular modification approaches during the growth or expression phase can be implemented to achieve products having desired features including, for example and without limitation, enhanced sensory alignment with traditional products, neutral flavor profiles suitable for ingredient applications, improved nutritional characteristics, or combinations thereof. The enzymatic modification approaches can reduce or eliminate the use of additives in later processing phases while providing flexibility for various commercial applications.

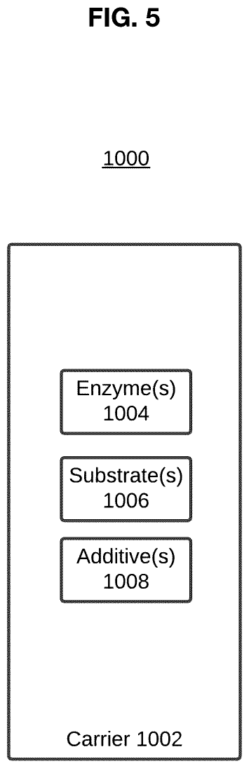

Referring now to FIG. 4A, for purpose of illustration only and not limitation, an exemplary manufacturing process for a cultivated food product is shown. As shown in FIG. 4A, for example and without limitation, manufacturing process 400 for a cultivated food product can include cell and media creation at 402, growth (e.g., in a bioreactor or on a substrate) at 404, harvest and process protein material at 406, and additive flavoring and processing into a final product at 408. As embodied herein, system 100 and method 200 can adjust the manufacturing process during the cell and media creation phase and/or the growth phase of the cultivated food product manufacturing process as described herein to affect attributes of interest, including but not limited to flavor. Such adjustment during these earlier phases can reduce or eliminate the use of additives, including but not limited to flavoring additives, to be added to the cultivated food product in later phases, such as during the additive flavoring and processing phase.

Referring now to FIG. 4B, for purpose of illustration only and not limitation, an exemplary manufacturing process for a precision fermented product is shown. As shown in FIG. 4B, for purpose of illustration and not limitation, manufacturing process 420 for a precision fermented product can include feedstock and microorganism creation at 422, growth and expression (e.g., in a bioreactor) at 424, harvest protein (e.g., involving killing the microorganism and/or purification of target protein) at 426, drying or lyophilization of target protein at 428, rehydration of target protein at 430, combining with other ingredients for base solution 432, and additive flavoring and processing into a final product at 434. As embodied herein, system 100 and method 200 can adjust the manufacturing process during the growth and expression phase, during the rehydration phase, or in a base solution of a precision fermented product manufacturing process as described herein to affect attributes of interest, including but not limited to flavor. Such adjustment during these growth and expression, rehydration phase, or base solution can reduce or eliminate the use of additives, including but not limited to flavoring additives, to be added to the precision fermented product in later phases, such as during the additive flavoring and processing phase.

Referring now to FIG. 4C, for purpose of illustration only and not limitation, an exemplary manufacturing process for a plant-based substitute product is shown. As shown in FIG. 4C, for example and without limitation, manufacturing process 440 for a plant-based substitute product can include growing, planting and harvesting at 442, processing protein ingredients at 444, extruding at 446, encapsulation or restructuring at 448, and additive flavoring and processing into a final product at 450. As embodied herein, system 100 and method 200 can adjust the manufacturing process during the growth phase and/or processing protein ingredients phase of the plant-based substitute product manufacturing process as described herein to affect attributes of interest, including but not limited to flavor. Such adjustment during these earlier phases can reduce or eliminate the use of additives, including but not limited to flavoring additives, to be added to the plant-based substitute product in later phases, such as during the additive flavoring and processing phase.

According to other aspects of the disclosed subject matter, culture supplement compositions for producing an adjusted cellular agriculture product are provided. In accordance with the disclosed subject matter herein, a culture supplement composition for producing an adjusted cellular agriculture product, includes a formulation including at least one enzyme in a carrier. As embodied herein, the formulation can be configured to adjust production of a base cellular agriculture product to produce an adjusted cellular agriculture product without reducing or inhibiting biomass production or cellular viability compared to the base cellular agriculture product. Additionally or alternatively, as embodied herein, the culture supplement composition can further include, in the carrier, at least one of a substrate or an additive.

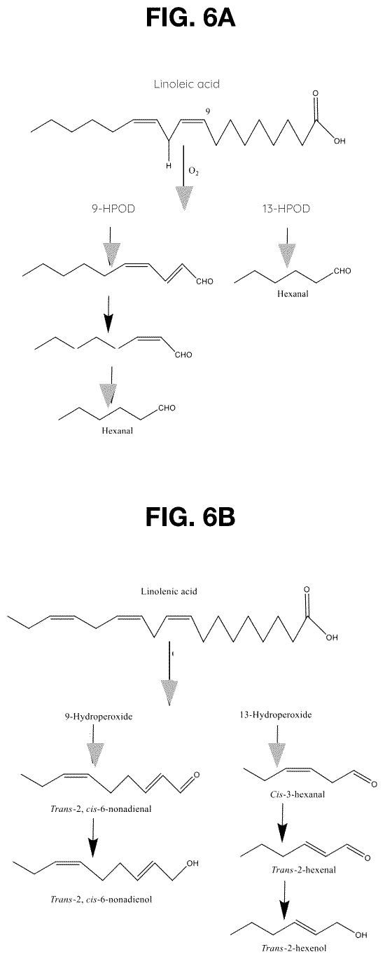

For purpose of illustration and not limitation, reference is made to the exemplary embodiments of culture supplement compositions shown in FIG. 5. With reference to FIG. 5, a culture supplement composition 1000 can generally include, in a carrier 1002, one or more enzyme(s) 1004. Culture supplement composition 1000 can further include, as embodied herein, one or more substrate(s) 1006 or additive(s) 1008 in carrier 1002. As embodied herein, culture supplement composition 1000 can be configured to adjust production of a base cellular agriculture product to produce an adjusted cellular agriculture product without reducing or inhibiting biomass production or cellular viability compared to the base cellular agriculture product.

As embodied herein, carrier 1002 can include an emulsifier solution, powder, gel, or solid substrate. For example and without limitation, the emulsifier solution can include one or more of a nonionic detergent, a nonionic triblock copolymer, a nonionic surfactant, a poloxamer, and a zwitterionic detergent. As embodied herein, carrier 1002 can have a concentration from 0.5% v/v to 5% v/v.

Additionally or alternatively, as embodied herein, enzyme(s) 1004 can include one or more of a fatty acid desaturase, a cyclooxygenase, a lipoxygenase, an elongase, an oxidoreductase, a transferase, an endopeptidase, an exopeptidase, a hydrolase, a lyase, an isomerase, or a ligase. For example and without limitation, enzyme(s) 1004 can have a concentration from 0.1% w/v to 3% w/v with enzymatic activity from 20000 to 20 units/mg.

Furthermore, or as an alternative, as embodied herein, substrate(s) 1006 can include one or more of a saturated fatty acid, a monounsaturated fatty acid, a polyunsaturated fatty acid, an omega-3 fatty acid, an omega-6 fatty acid, a peptide, a protein, a nucleotide or an amino acid. For example and without limitation, substrate(s) 1006 can have a concentration from 0.1 mM to 50 mM. Additionally or alternatively, substrate(s) 1006 can have a concentration from 0.1 mg/mL to 1 mg/mL.

In addition, or as a further alternative, as embodied herein, additive(s) 1008 can include one or more of a growth factor protein, an insulin hormone, and a transport protein.

Culture supplement composition 1000 can be made, for example and without limitation, by mixing the components of the culture supplement composition 1000 in the amounts or proportions described herein. Moreover, or as an alternative, each component of the culture supplement composition 1000 can be added to a vessel in a sterile environment (e.g., a flask or beaker) in specified amounts and mixed until homogeneity. Additionally or alternatively, as embodied herein, processing circuitry 104 can control, directly or indirectly, operation of a mixer to produce culture supplement compositions 1000 as described herein.

Additionally or alternatively, as embodied herein, culture supplement composition 1000 can be formulated to implement molecular modification approaches in cellular agriculture protein products. For example and without limitation, as embodied herein, the enzymatic formulations can be configured to achieve enhanced alignment with traditional product characteristics, neutral sensory profiles with substantially reduced off-flavor compounds, improved nutritional profiles, enhanced functional properties, or combinations thereof. Such molecular modification approaches enable manufacturers to target consumer markets, ingredient applications, or integrated formulations suitable for a variety of commercial requirements using adaptable enzymatic treatment parameters. The molecular modification approaches can be implemented through controlled enzymatic treatments that can be adjusted based on desired product features, including for example and without limitation, reference product alignment for consumer applications, neutral flavor profiles for ingredient manufacturing, enhanced nutritional characteristics for functional foods, or integrated approaches that provide versatility across multiple market segments.

Culture supplements can include, for purpose of illustration and not limitation, media supplements for cultivated agriculture products, supplements for precision fermentation, and other supplements for production of cellular agriculture products. Culture supplement composition 1000 can be formulated to be added to a cell culture medium used to produce cells of a base cellular agriculture product at a concentration from 1% v/v to 15% v/v. For purpose of illustration and not limitation, culture supplement composition can be configured to modify at least one of a growth phase, an expression phase, a rehydration phase, an encapsulation or a restructuring phase of the base cellular agriculture product. As embodied herein, culture supplement composition 1000 can be configured to modify a growth phase or an expression phase of the base cellular agriculture product, which can be prior to a structuring, restructuring, or other phase involving use of additives to improve attributes of the base cellular agriculture product. Culture supplement composition 1000 can be added to a growth media in a production vessel, such as a bioreactor or other vessel suitable for biomass growth. Additionally or alternatively, as embodied herein, processing circuitry 104 can be configured to control, directly or indirectly, operation of manufacturing component 108 including the production vessel. Culture supplement composition 1000 can thus be used to grow cells to produce an adjusted cellular agriculture product made using culture supplement composition 1000 as described herein. As embodied herein, the adjusted cellular agriculture product can have a similar cellular growth or cellular viability compared to the base cellular agriculture product.

According to other aspects of the disclosed subject matter, culture supplement compositions for producing an adjusted cellular dairy product include a formulation including, in a carrier, at least one enzyme, where the formulation is configured to adjust production of a base cellular dairy product including cellular dairy proteins to produce an adjusted cellular dairy product having increased alignment of one or more dairy attributes with a target reference compared to the base cellular dairy product without reducing cellular growth or cellular viability.

According to other aspects of the disclosed subject matter, methods for cellular attribute alignment of a base cellular dairy product include accessing, using processing circuitry and first data stored in memory, a compositional profile of one or more target compounds affecting one or more dairy attributes of a target reference, determining, using the processing circuitry, at least one compositional gap in the base cellular dairy product by comparison of the compositional levels of the one or more target compounds in the first data to corresponding compositional levels in second data including a compositional profile of the base cellular dairy product, and providing, using the processing circuitry, a culture supplement composition including a formulation including, in a carrier, at least one enzyme, where the formulation is configured to adjust production of the base cellular dairy product including cellular dairy proteins to produce an adjusted cellular dairy product having increased alignment of one or more dairy attributes with the target reference compared to the base cellular dairy product without reducing cellular growth or cellular viability.

According to other aspects of the disclosed subject matter, systems for cellular attribute alignment of a base cellular dairy product are provided including one or more memories configured to store first data including one or more target compounds affecting one or more dairy attributes of a target reference and second data including a compositional profile of a base cellular dairy product, and processing circuitry configured to identify, using the first data, one or more target compounds affecting the one or more dairy attributes, determine at least one compositional gap in the base cellular dairy product by comparison of compositional levels of the one or more target compounds, and provide a culture supplement composition including a formulation including, in a carrier, at least one enzyme, where the formulation is configured to adjust production of the base cellular dairy product including cellular dairy proteins to produce an adjusted cellular dairy product having increased alignment of one or more dairy attributes with the target reference compared to the base cellular dairy product.

According to other aspects of the disclosed subject matter, adjusted cellular dairy products are provided. In accordance with the disclosed subject matter herein, an adjusted cellular dairy product is produced using a culture supplement composition including a formulation including, in a carrier, at least one enzyme configured to adjust production of a base cellular dairy product including cellular dairy proteins to produce an adjusted cellular dairy product having increased alignment of one or more dairy attributes with a target reference compared to the base cellular dairy product, where the adjusted cellular dairy product has increased alignment of the one or more dairy attributes with the target reference compared to the base cellular dairy product.

Using cellular agriculture protein products by way of example only and not limitation, compositional levels affecting one or more attributes including without limitation flavor and odor, can be adjusted using the systems, compositions and techniques of the disclosed subject matter. As embodied herein, an adjusted cellular agriculture product can be produced, for example and without limitation, including a flavor profile and an odor profile having increased alignment with a reference product. Such a flavor profile and odor profile can be obtained, as embodied herein, without or with reduced use of additives, including but not limited to flavoring or scented additives, added to the cellular agriculture product in later phases, such as during the additive flavoring and processing phase. For example and without limitation, as embodied herein, the enzymatic approaches disclosed herein can also be used to substantially reduce or eliminate undesirable flavor compounds to achieve neutral sensory characteristics suitable for ingredient applications where reduced or minimized flavor interference is desired

As embodied herein, compositional profiling of cellular agriculture protein products and reference products can provide detailed insights into molecular components affecting attributes of interest, including but not limited to flavor, odor, texture, and nutritional characteristics. For purpose of illustration and not limitation, compositional profiling can be performed using one or more analytical techniques to generate data sets to identify target compounds affecting the attributes having compositional gaps between base cellular agriculture protein products and reference products.

Additionally or alternatively, as embodied herein, compositional profiling can utilize digital sensory evaluation systems to obtain data sets for analysis. For example and without limitation, extraction-quantification component 106 can include or communicate with a digital nose system and a digital tongue system configured to provide electronic sensory evaluation of cellular agriculture protein products and reference products. As embodied herein, the digital nose system can include an array of gas sensors configured to detect and quantify volatile organic compounds (VOCs) contributing to odor profiles, while the digital tongue system can include an array of taste sensors configured to detect and quantify non-volatile compounds contributing to taste profiles. The digital nose and digital tongue systems can generate electronic signatures or fingerprints that correlate with human sensory perception, providing objective and reproducible measurements of sensory attributes that can be stored as compositional profile data in memory 102.

Furthermore, or as an alternative, and as embodied herein, data obtained from digital sensory evaluation systems can be correlated with data obtained from traditional sensory evaluation techniques to validate and calibrate the electronic measurements. For purpose of illustration and not limitation, sensory panel data obtained from trained human evaluators can be used to establish correlations between electronic sensor responses and human sensory perception. Such correlations can enable processing circuitry 104 to translate electronic measurements into sensory attribute predictions, which can associate objective analytical data and subjective consumer experience. As embodied herein, the correlation data can be stored in memory 102 and can be used to perform or refine the identification of target compounds affecting attributes of interest in reference products.

Moreover, or as a further alternative, as embodied herein, compositional profiling can utilize calibration samples to increase accuracy and reproducibility of analytical measurements. For example and without limitation, calibration samples can include known reference standards containing selected concentrations of target compounds identified as affecting attributes of interest. As embodied herein, calibration samples can be prepared by mixing individual components at desired concentrations in appropriate solvents, which can provide standards that span expected concentration ranges of target compounds in cellular agriculture protein products and reference products. The calibration samples can be analyzed using the same analytical techniques applied to test samples, which can allow processing circuitry 104 to generate calibration curves and correct for instrumental variations or matrix effects.

Additionally or alternatively, as embodied herein, compositional profile data can be analyzed using processing circuitry 104 configured to identify and quantify flavor and aroma compounds. For purpose of illustration and not limitation, data analysis can be performed using AroChemBase database in conjunction with AlphaSoft V2023 software or similar analytical software platforms. As embodied herein, AroChemBase can provide a comprehensive library of flavor and aroma compounds with associated sensory descriptors, odor thresholds, and chemical properties, which can allow processing circuitry 104 to identify and characterize target compounds detected in compositional profiles. In addition, or as a further alternative, as embodied herein, AlphaSoft V2023 or similar software can perform data processing including peak identification, integration, quantification, and statistical analysis of complex analytical datasets. Thus, processing circuitry 104 can be configured to utilize database resources and analytical software can to provide automated identification of compositional gaps and generate recommendations for manufacturing process adjustments.

Furthermore, or as an alternative, as embodied herein, consumer preferences can be identified by analyzing leading products commercially sold in the market to identify reference products having attributes of interest aligned with consumer acceptance. For purpose of illustration and not limitation, market analysis can include compositional profiling of commercially successful cellular agriculture protein products and traditional protein products to identify molecular signatures associated with consumer preference. As embodied herein, processing circuitry 104 can analyze sales data, consumer reviews, market share information, and sensory evaluation data for leading commercial products to establish correlations between compositional profiles and market success. Such market-based reference data can be stored in memory 102 and can be used to guide the selection of reference products and the identification of target compounds for attribute alignment. Additionally or alternatively, as embodied herein, consumer preference data can be obtained from focus groups, taste panels, and market research studies to provide direct feedback on sensory attributes and purchase intent, which can allow processing circuitry 104 to rank or weight the importance of different target compounds based on an impact on consumer acceptance.

As embodied herein, one or more of digital sensory evaluation, traditional sensory panels, calibration standards, analytical software, and market-based consumer preference data can be utilized in compositional profiles that can be used to identify molecular targets for cellular agriculture protein product adjustment. The resulting compositional profiles can be used to determine manufacturing process adjustments, including for example formulating culture supplement compositions to produce adjusted cellular agriculture protein products having improved alignment with consumer preferences and reference product attributes.

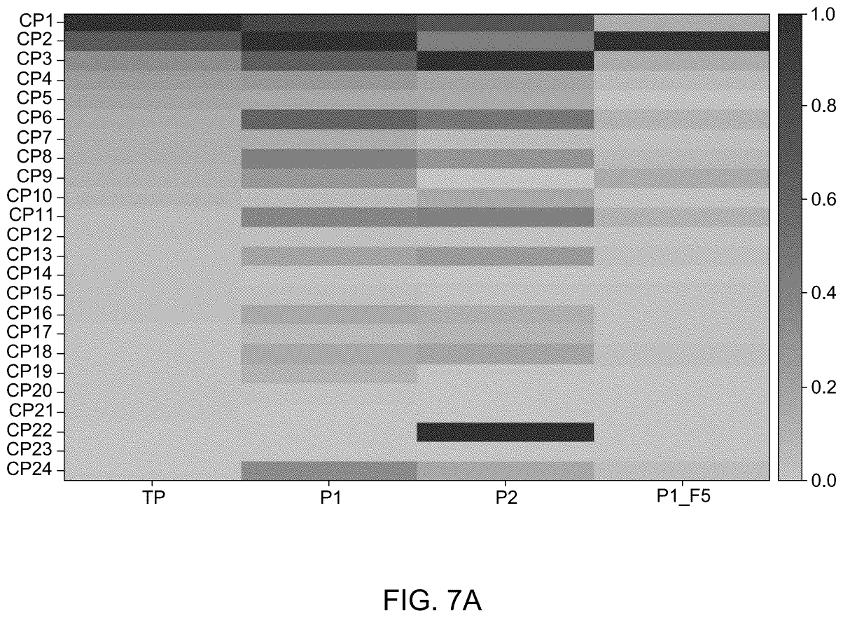

Referring now to FIGS. 6A and 6B, for purpose of illustration and not limitation, targeted enzyme pathways for flavor alignment are shown, illustrating exemplary biochemical transformations that can be utilized to generate desirable flavor compounds associated with traditional dairy products. As embodied herein, FIGS. 6A and 6B illustrate enzymatic conversion pathways that can be implemented in culture supplement compositions 1000 to produce flavor-active compounds contributing to buttery, nutty, and creamy sensory notes characteristic of cow milk and other dairy reference products.

As shown in FIG. 6A, linoleic acid can provide a substrate for targeted enzymatic conversion to produce specific flavor compounds found in traditional dairy products and sunflower oil. Linoleic acid as embodied herein can be an 18-carbon polyunsaturated fatty acid having two double bonds at the 9th and 12th carbon positions, which can provide reactive sites for regioselective enzymatic oxidation. The enzymatic pathway can exhibit molecular oxygen (O₂) incorporation at positions to form 9-HPOD and 13-HPOD hydroperoxide intermediates, which can represent branch points to determine the final flavor compound profile. The 13-HPOD intermediate can undergo enzymatic cleavage to produce hexanal, a 6-carbon saturated aldehyde that can contribute to creamy and buttery flavor characteristics. As embodied herein, the 9-HPOD intermediate can be converted to a 9-carbon unsaturated aldehyde that can provide nutty flavor notes.

As shown in FIG. 6B, linolenic acid can provide an alternative substrate for targeted enzymatic conversion. Linolenic acid as embodied herein can be an 18-carbon polyunsaturated fatty acid having three double bonds at the 9th, 12th, and 15th carbon positions. The increased degree of unsaturation can allow for generation of different flavor compound profiles with increased complexity. The 9-hydroperoxide intermediate can be converted to trans-2, cis-6-nonadienal, which can undergo further processing to form trans-2, cis-6-nonadienol, which can contribute to nutty and creamy flavor characteristics. The 13-hydroperoxide intermediate can generate cis-3-hexenal, which can undergo sequential conversion to trans-2-hexenal and then to trans-2-hexenol, to provide enhanced buttery and nutty notes.

As embodied herein, the targeted enzyme pathways illustrated for example in FIGS. 6A and 6B can be implemented in culture supplement composition 1000 by incorporating selected lipoxygenase enzymes, hydroperoxide lyase, alcohol dehydrogenase, and isomerase enzymes along with the respective fatty acid substrates. For example and without limitation, the culture supplement composition 1000 can include 9-lipoxygenase, 13-lipoxygenase, and associated processing enzymes configured to catalyze the sequential conversion reactions shown in the pathways. The enzymatic systems can be selected to preferentially generate hexanal, nonadienol, hexenol, and other dairy-associated flavor compounds while controlling the relative concentrations through adjustment of enzyme ratios, substrate concentrations, and reaction conditions.

TABLE 1

| | | | Exemplary |
|---|---|---|---|
| | | | Inclusion |
| | | Exemplary | Amount(s) - |
| Formulation | Components | Ratio(s) | Range |
| Dairy Enzyme | Transferase, | 1:1:1, 2:2:1, | 0.1% to 2% |
| Combination I | telopeptidase, and | 1:1.5:1.5, | |
| | hydrolase | 2:3:1, OR | |
| | | 1:2:1.5 | |
| Dairy Enzyme | Transferase, | 1:1:1, 2:2:1, | 0.1% to 2% |
| Combination II | telopeptidase, and | 1:1.5:1.5, | |
| | hydrolase | 2:3:1, OR | |
| | | 1:2:1.5 | |
| Formulation 1 | 1% w/v Glycoside | N/A | 0.1% to 2% |
| | hydrolase | | |
| Formulation 2 | 1% w/v Transferase | N/A | 0.1% to 2% |
| Formulation 3 | 1% v/v Endopeptidase | N/A | 0.1% to 2% |
| Formulation 4 | 1% v/v Telopeptidase | N/A | 0.1% to 2% |
| | Combination (including | | |
| | two to three of the | | |
| | following aminopeptidases, | | |
| | dipeptidyl peptidases, | | |
| | endopeptidases, and | | |
| | hydrolase) | | |
| Formulation 5 | 1% v/v hydrolase | N/A | 0.1% to 2% |
| Formulation 6 | 0.3% w/v Peroxidase | N/A | 0.1% to 2% |
| Formulation 7 | 1% w/v 1:1 Hydrolase/ | 1:1; 1:1.5, | 0.1% to 2% |
| | Transferase blend | 2:1, OR 3:1 | |
| Formulation 8 | 1% v/v 1:1 Hydrolase, | 1:1; 1:1.5, | 0.1% to 2% |
| | peroxidase | 2:1, OR 3:2 | |
| Formulation 9 | 1% w/v oxygenase + | 1 mM to 50 mM | 0.1% to 2% |
| | 50 mM precursor | precursor | |
| Formulation 10 | 1% w/v oxygenase + | 1 mg to 500 mg of at | 0.1% to 2% |
| | 1% v/v Fish oil Blend: | least one of the | |
| | 180 mg EPA, 120 mg DHA, | following fatty acids | |
| | 5 mg cholesterol, + | DHA, EPA, Linoleic | |
| | 500 mg Linoleic and | acid, Oleic Acid, | |
| | 500 mg Oleic acid | Arachidonic acid | |
| Formulation 11 | Hydrolase/Transferase, | 1:1:1, 2:2:1, | 0.1% to 2% |
| | oxygenase | 1:1.5:1.5, | |
| | | 2:3:1, OR | |
| | | 1:2:1.5 | |

Furthermore, or as an alternative, as embodied herein, the targeted enzyme pathway approaches shown in FIGS. 6A and 6B can provide advantages over conventional flavoring techniques by generating flavor compounds in-situ during the cellular agriculture production process. This enzymatic approach can allow for production of fresh, authentic flavor notes without external flavor additives, thereby maintaining a clean ingredient label while achieving superior sensory alignment with reference dairy products. For example and without limitation, as embodied herein, the enzymatic approach can also be used to produce neutral ingredient bases with substantially reduced off-flavor compounds, maintaining a clean ingredient label suitable for a variety of commercial applications including ingredient manufacturing. The enzymatic conversion can be integrated into various phases of manufacturing component 108 operation, including growth phases, expression phases, or post-harvest processing phases, to improve flavor development and product quality while maintaining cellular viability and production efficiency. For example and without limitation, as embodied herein, the degree of enzymatic modification can be controlled to achieve enhanced alignment with reference dairy products, and can also be used to achieve neutral flavor profiles suitable for ingredient applications.

For example and not limitation, as embodied herein, Table 1 includes exemplary formulations for culture supplement compositions 1000 to target enzyme pathways illustrated in FIGS. 6A and 6B and in accordance with the disclosed subject matter. As shown for example in Table 1, the exemplary formulations can include the corresponding components, at any of the corresponding ratios (if applicable), and having an inclusion amount in the corresponding ranges.

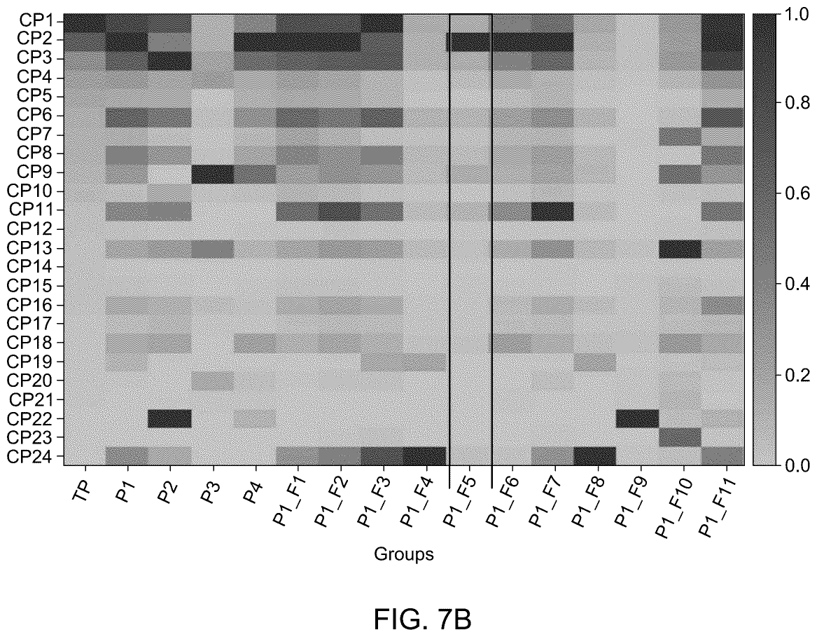

Referring now to FIGS. 7A and 7B, for purpose of illustration and not limitation, exemplary embodiments of compositional profiles obtained from electronic nose analysis are shown, illustrating compound profiles of reference products, base cellular agriculture products, and adjusted cellular agriculture products for purpose of comparison. As embodied herein, FIGS. 7A and 7B illustrate compositional profile data generated by extraction-quantification component 106 configured as a digital nose system (e.g., using HERACLES e-nose from Alpha MOS) to provide electronic sensory evaluation and quantification of volatile organic compounds contributing to odor profiles of dairy products and cellular agriculture dairy products. For example and not limitation, as shown in FIGS. 7A and 7B, exemplary compounds can include one or more of the following: CP1 can be maltol, CP2 can be butanoic acid, CP3 can be hexanoic acid; butyl butanoate, CP4 can be pentanoic acid; 2-heptanone, CP5 can be 2-methylpropanoic acid, CP6 can be hexyl acetate; limonene; trimethylpyrazine, CP7 can be 2-methylpropanoic acid, CP8 can be gamma-Terpinene; acetophenone; 4-hydroxy-5-methyl-3 (2H)-furanone, CP9 can be propanal; propanol, CP10 can be propanoic acid, CP11 can be 2-methylpropanal; propanal, CP12 can be 3-methylbutanoic acid, CP13 can be butane-23-dione, CP14 can be dihydro-2 (3H)-furanone, CP15 can be furfural; butanoic acid, CP16 can be dodecanal; delta-nonalactone, CP17 can be decanoic acid, CP18 can be pentanal, CP19 can be butanal, CP20 can be 23-pentanedione, CP21 can be 3-methylbutanal; n butanol, CP22 can be acetaldehyde; ethanol, CP23 can be acetic acid; 3-methylbutanal, and CP24 can be Isopropyl acetate; 3-methylbutanal.

As shown in FIG. 7A, compositional profiles of the most discriminative volatile compounds in odors from a reference product (TP1), which was a commercial dairy product, base cellular agriculture products (P1 and P2), which were commercial cellular agriculture dairy products with P2 being a flavored variant, and P1 adjusted with an enzyme formulation (P1_F5 corresponding to Formulation 5 of Table 1) are presented in a comparative heat map format. The compositional profile data shows relative concentrations of volatile organic compounds using an intensity scale ranging from 0.0 to 1.0, where darker regions indicate higher concentrations of specific volatile compounds and lighter regions indicate lower concentrations. As embodied herein, the volatile compounds identified include flavor-active molecules such as butanoic acid, hexanoic acid, butyl butanoate, pentanoic acid, 2-heptanone, 2-methylpropanoic acid, and various terpenes and aldehydes that contribute to characteristic dairy odor profiles.

Additionally or alternatively, as embodied herein, FIG. 7A illustrates compositional gaps between the reference product (TP1) and the base cellular agriculture products (P1 and P2). For example and without limitation, the reference product TP1 shows elevated concentrations of butanoic acid, hexanoic acid, and butyl butanoate compounds, which can be characteristic of traditional dairy products and contribute to creamy, buttery, and nutty flavor notes. In contrast, the base cellular agriculture products P1 and P2 exhibit substantially lower concentrations of these key dairy-associated volatile compounds, indicating compositional gaps that affect sensory alignment with the reference product. Adjusted cellular dairy product (P1_F5) adjusted with enzyme formulation F5 shows an intermediate profile indicating an improved alignment in volatile compound generation with the reference product TP1 compared to the base products P1 and P2 without the enzymatic adjustment.

As shown in FIG. 7B, an expanded compositional profile analysis is presented, illustrating additional adjusted cellular dairy products (P1_F1 through P1_F11) representing base cellular agriculture product P1 adjusted with enzyme Formulations 1-11 of Table 1. The heat map demonstrates volatile compound profiles across multiple treatment groups, with the reference product (TP) and base cellular agriculture products (P1 and P2) serving as comparative controls. As embodied herein, the expanded analysis includes additional volatile compounds and illustrates the effects of different culture supplement compositions 1000 on volatile compound generation.

Furthermore, as embodied herein, FIGS. 7A and 7B illustrate the effectiveness of targeted enzyme formulations in reducing compositional gaps between base cellular agriculture products and the reference product. For purpose of illustration and not limitation, Formulation 5 (P1_F5) shows improved alignment with the reference product volatile compound profile, including for dairy-associated compounds such as butanoic acid, hexanoic acid, and various aldehydes and esters. The compositional profile data illustrates enzyme formulations disclosed herein can generate volatile compound profiles that more closely resemble the reference product, thereby improving sensory alignment and consumer acceptance.

Moreover, as embodied herein, the electronic nose compositional profiling demonstrated in FIGS. 7A and 7B provides objective, quantitative measurements of volatile organic compounds that correlate with human sensory perception of dairy products. The digital nose system generates electronic signatures that can be stored as compositional profile data in memory 102 and analyzed by processing circuitry 104 to identify target compounds affecting odor attributes of interest. As embodied herein, the compositional profile data can be used by processing circuitry 104 to determine compositional gaps between base cellular agriculture products and reference products, and to formulate culture supplement compositions 1000 configured to reduce or eliminate these compositional gaps.

Additionally or alternatively, as embodied herein, the comparative analysis shown in FIGS. 7A and 7B illustrates the capability of system 100 to evaluate the effectiveness of different manufacturing process adjustments and culture supplement formulations. The electronic nose data provides quantitative feedback on the suitability of enzymatic approaches in generating desired volatile compounds, which can allow for iterative refinement of formulations of culture supplement compositions 1000 to achieve improved sensory alignment with reference dairy products. The compositional profiling approach illustrated in FIGS. 7A and 7B can be applied to various cellular agriculture products to identify molecular targets for attribute alignment and to validate the effectiveness of manufacturing process modifications in producing adjusted cellular agriculture products having enhanced consumer acceptance. For example and without limitation, as embodied herein, the compositional profiling can also be used to achieve neutral flavor profiles by substantially reducing or eliminating undesirable volatile compounds for ingredient applications as described herein.

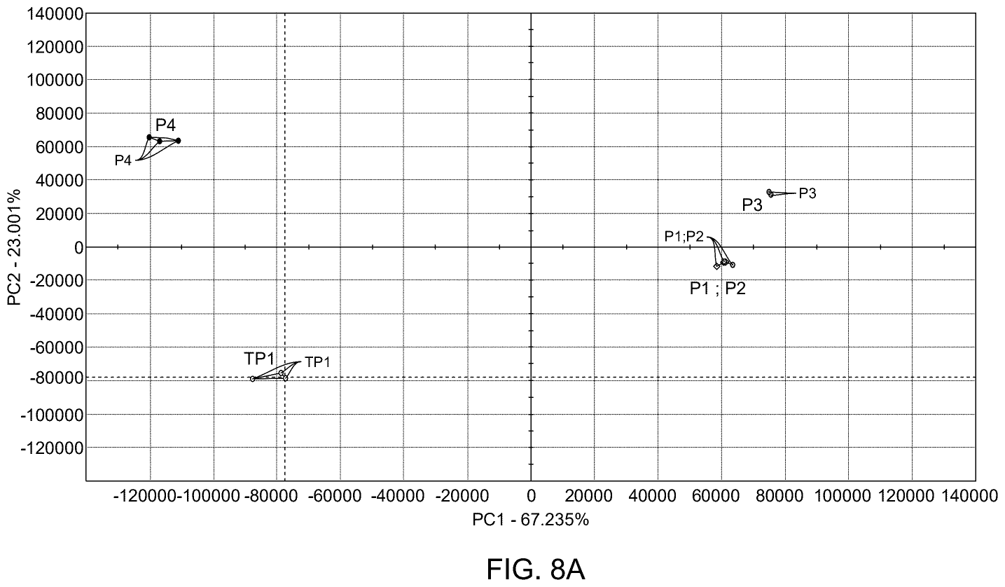

Referring now to FIGS. 8A and 8B, for purpose of illustration and not limitation, principal component analysis (PCA) odor maps are shown, illustrating multivariate statistical analysis of compositional profiles obtained from electronic nose evaluation of reference products, base cellular agriculture products, and adjusted cellular agriculture products in accordance with the disclosed subject matter. As embodied herein, FIGS. 8A and 8B illustrate PCA-based dimensional reduction of the volatile organic compound datasets to visualize relationships and differences between product samples in a two-dimensional space defined by principal components that capture the greatest variance in the compositional profile data.

As shown in FIG. 8A, a PCA odor map is presented comparing a reference commercial dairy product (TP1) with four base cellular dairy products (P1 through P4), demonstrating significant misalignment between the base cellular agriculture products and the reference product. The first principal component (PC1) accounts for 67.235% of the total variability in the volatile compound profiles, while the second principal component (PC2) accounts for 23.00% of the total variability, together representing 90.235% of the total variance in the dataset. As embodied herein, the spatial separation between the reference product TP1 and the base cellular agriculture products P1 through P4 in the PCA space can quantitatively illustrate the compositional gaps in volatile organic compounds that drive odor misalignment between traditional dairy products and cellular agriculture dairy products.

Additionally or alternatively, as embodied herein, FIG. 8A illustrates that the base cellular dairy products P1 through P4 cluster together in a distinct region of the PCA space that is spatially separated from the reference product TP1, which can indicate systematic differences in volatile compound profiles. For purpose of illustration and not limitation, the clustering of base cellular agriculture products can indicate consistent compositional deficiencies across multiple commercial cellular agriculture dairy products compared to the reference traditional dairy product. The spatial distance between the reference product and base cellular agriculture products in the PCA space can provide a quantitative measure of sensory misalignment that can be stored in memory 102 and analyzed by processing circuitry 104 to identify volatile compounds contributing to the observed differences.

As shown in FIG. 8B, an expanded PCA odor map is presented that includes the products from FIG. 8A together for purpose of comparison with adjusted cellular dairy products made from base product P1 adjusted using each of Formulations 1-11 of Table 1 (designated as P1_F1 through P1_F11). The PCA analysis illustrates that enzymatic adjustment using culture supplement compositions 1000 corresponding to the formulations of Table 1 can improve odor alignment with the reference dairy product TP1 by reducing the spatial distance in the PCA space. As embodied herein, several of the adjusted cellular agriculture products treated with culture supplement compositions 1000, show movement toward the reference product TP1 in the PCA space, which can indicate improved volatile organic compound profiles that more closely resemble traditional dairy products.

Furthermore, as embodied herein, FIG. 8B illustrates differential effectiveness of various enzyme formulations in achieving sensory alignment with the reference product. For example and without limitation, formulations such as P1_F5, P1_F9, and P1_F10 demonstrate greater movement toward the reference product TP1 in the PCA space compared to other formulations, which can indicate superior performance in generating volatile compounds that contribute to dairy-like odor characteristics. The PCA analysis can be used by processing circuitry 104 to rank the effectiveness of different culture supplement compositions 1000 based at least in part on ability to reduce compositional gaps and improve sensory alignment with reference products.

Moreover, as embodied herein, the PCA odor maps shown in FIGS. 8A and 8B can provide a useful visualization tool for evaluating the success of manufacturing process adjustments in producing adjusted cellular agriculture products with improved sensory characteristics. The two-dimensional representation of complex multi-compound datasets can allow for rapid assessment of product similarity and identification of formulations that achieve the greatest improvement in sensory alignment. As embodied herein, processing circuitry 104 can utilize PCA analysis to identify desirable culture supplement compositions 1000 and manufacturing process parameters that can reduce or minimize the distance between adjusted cellular agriculture products and reference products in the multidimensional volatile compound space.

Additionally or alternatively, as embodied herein, the PCA analysis demonstrated in FIGS. 8A and 8B can be integrated into method 200 for cellular attribute alignment by providing quantitative metrics for evaluating the effectiveness of manufacturing process adjustments. The spatial coordinates of products in the PCA space can be stored in memory 102 as compositional profile data and used by processing circuitry 104 to iteratively evaluate culture supplement formulations and processing conditions. The PCA approach can allow for systematic evaluation of multiple formulation variables simultaneously, which can facilitate efficient development of adjusted cellular agriculture products that achieve superior sensory alignment with consumer preferences and reference product attributes.

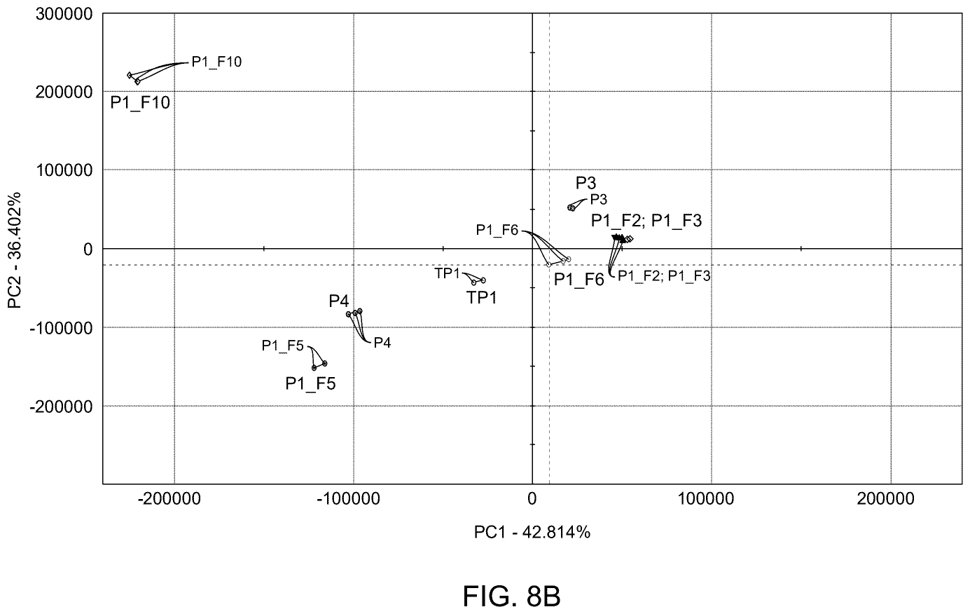

Referring now to FIG. 9, for purpose of illustration and not limitation, a quantitative analysis of volatile organic compound levels is shown, illustrating compositional profiles of a reference dairy product (TP1), base cellular dairy products (P1 and P2), and an adjusted cellular dairy product (P1_F5) produced using Formulation 5 of Table 1 in accordance with the disclosed subject matter. As embodied herein, FIG. 9 illustrates volatile organic compound concentrations expressed as percentage of total volatiles, providing quantitative measurements of flavor-active compounds that can contribute to dairy-associated sensory characteristics and allow for evaluation of compositional gaps and alignment improvements achieved through enzymatic adjustment.

As shown in FIG. 9, the reference dairy product (TP1) exhibits characteristic volatile compound profiles with elevated concentrations of dairy-associated compounds that contribute to authentic dairy flavor and aroma characteristics. For purpose of illustration and not limitation, the reference product TP1 exhibits high concentrations of butter fatty compounds including hexanal and butanoic acid at approximately 21.5% of total volatiles respectively, which can be characteristic of traditional dairy products and can contribute to creamy, buttery flavor notes highly valued by consumers. Additionally or alternatively, as embodied herein, the reference product shows significant levels of nutty and sweet fatty compounds including benzaldehyde and butyl compounds at approximately 10.2% of total volatiles, which can contribute to the complex flavor profile associated with premium dairy products.

Additionally or alternatively, as embodied herein, FIG. 9 demonstrates substantial compositional gaps between the base cellular agriculture products (P1 and P2) and the reference product (TP1) across several volatile compound categories. For example and without limitation, base cellular agriculture product P1 shows reduced concentrations of butter fatty compounds, with hexanal and butanoic acid levels at approximately 17.2% of total volatiles, representing compositional deficiencies compared to the reference product. The base cellular agriculture product P2, despite being a flavored variant, exhibits similar compositional gaps with hexanal and butanoic acid concentrations at approximately 8.5% of total volatiles respectively, which can indicate that conventional flavoring approaches can be ineffective to address the underlying volatile compound deficiencies.

Furthermore, as embodied herein, FIG. 9 illustrates the effectiveness of enzymatic adjustment using culture supplement composition 1000 corresponding to Formulation 5 of Table 1 in reducing compositional gaps and improving alignment with the reference product. The adjusted cellular dairy product (P1_F5) exhibits improved volatile compound profiles across multiple categories, with hexanal and butanoic acid concentrations reaching approximately 28.2% of total volatiles. As embodied herein, the enzymatic adjustment can improve butter fatty compound generation, with the adjusted product P1_F5 showing hexanal levels exceeding the reference product TP1, which can indicate enhancement of dairy-associated volatile compounds through targeted enzymatic conversion pathways.

Moreover, as embodied herein, the quantitative analysis shown in FIG. 9 illustrates differential improvements across various volatile compound categories following enzymatic adjustment. For purpose of illustration and not limitation, the adjusted product P1_F5 shows improved levels of cheese and coconut compounds, nutty and fruity compounds, and caramelized compounds compared to the base cellular agriculture products P1 and P2, which can indicate broad-spectrum enhancement of dairy-associated volatile compounds through the enzymatic approach.

Additionally or alternatively, as embodied herein, FIG. 9 provides quantitative data that can be stored in memory 102 and analyzed by processing circuitry 104 to evaluate the effectiveness of culture supplement compositions 1000 in achieving targeted improvements in volatile compound profiles. The percentage values for each volatile compound category can be used by processing circuitry 104 to calculate compositional gap reductions and rank the performance of different enzymatic formulations based on ability to generate desired volatile compounds. As embodied herein, the quantitative measurements illustrate that Formulation 5 can improve dairy-associated volatile compounds in cellular dairy products, for example in the butter fatty compound identified as affecting dairy flavor perception. For example and without limitation, as embodied herein, the substantial modifications in volatile compound profiles illustrated in FIG. 9 can also be used to achieve neutral sensory characteristics through controlled reduction or elimination of specific off-flavor compounds as described herein.

Furthermore, as embodied herein, the volatile compound analysis illustrated in FIG. 9 can be used by processing circuitry 104 to identify molecular targets for further adjustment of culture supplement compositions 1000. For example and without limitation, the adjusted product P1_F5 shows substantial improvements in hexanal generation, and butanoic acid levels can be further adjusted to more closely match the reference product profile. The quantitative data can thus guide iterative refinement of enzymatic formulations and processing conditions to achieve improved volatile compound profiles that increase or maximize sensory alignment with reference dairy products while maintaining production efficiency and cellular viability in manufacturing component 108 operations.

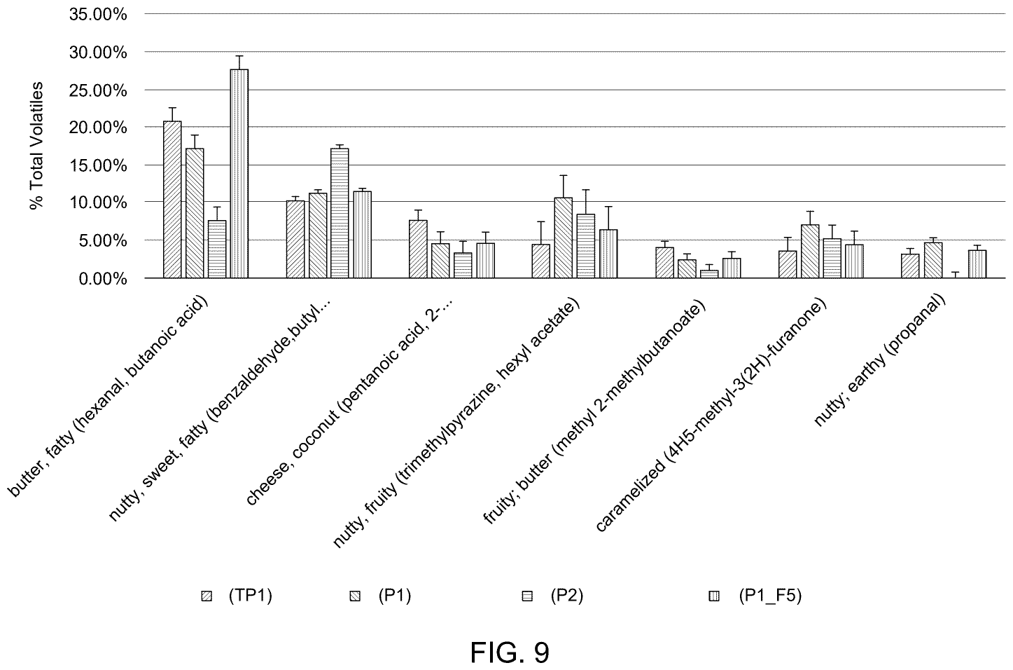

Referring now to FIGS. 10A and 10B, for purpose of illustration and not limitation, principal component analysis (PCA) taste maps are shown, illustrating multivariate statistical analysis of compositional profiles obtained from electronic tongue evaluation of reference products, base cellular agriculture products, and adjusted cellular agriculture products in accordance with the disclosed subject matter. As embodied herein, FIGS. 10A and 10B illustrate PCA-based dimensional reduction of taste sensor datasets generated using sensors of an exemplary digital tongue system (e.g., using ASTREE Electronic Tongue from Alpha MOS), including sensors referred to as AHS, PKS, CTS, NMS, CPS, and SCS sensors to visualize relationships and differences between product samples in a two-dimensional space defined by principal components that capture the greatest variance in the taste profile data.

As shown in FIG. 10A, a PCA taste map is presented comparing a reference commercial dairy product (TP1) with four base cellular dairy products (P1 through P4), illustrating misalignment between the base cellular agriculture products and the reference product in taste characteristics. The first principal component (PC1) accounts for 54.867% of the total variability in the taste sensor profiles, while the second principal component (PC2) accounts for 31.461% of the total variability, together representing 86.328% of the total variance in the dataset. As embodied herein, the spatial separation between the reference product TP1 and the base cellular agriculture products P1 through P4 in the PCA space can quantitatively show the compositional gaps in taste-active compounds that can drive flavor misalignment between traditional dairy products and cellular agriculture dairy products.

Additionally or alternatively, as embodied herein, FIG. 10A illustrates that the base cellular dairy products P1 through P4 cluster together in distinct regions of the PCA space spatially separated from the reference product TP1, which can indicate systematic differences in taste profiles. For purpose of illustration and not limitation, the reference product TP1 is positioned in the lower right quadrant of the PCA space, while the base cellular agriculture products are distributed across different quadrants, with P1 positioned near the center, P2 in the lower left quadrant, P3 in the upper right quadrant, and P4 in the upper left quadrant. The spatial distribution shows that volatile organic compound differences can drive taste misalignment between the reference dairy product TP1 and the base cellular agriculture product P1 being adjusted, which can provide quantitative evidence of the compositional gaps that can be stored in memory 102 and analyzed by processing circuitry 104.

As shown in FIG. 10B, an expanded PCA taste map is presented that includes the products from FIG. 10A together for purpose of comparison with adjusted cellular dairy products made from base product P1 adjusted using each of Formulations 1-11 of Table 1 (designated as P1_F1 through P1_F11). The PCA analysis demonstrates that enzymatic adjustment using culture supplement compositions 1000 corresponding to the formulations of Table 1 can improve flavor alignment with the reference dairy product TP1 by reducing the spatial distance in the PCA space. As embodied herein, several of the adjusted cellular agriculture products treated with specific enzyme formulations show movement toward the reference product TP1 in the PCA space, which can indicate improved taste profiles that more closely resemble traditional dairy products.

Furthermore, as embodied herein, FIG. 10B illustrates differential effectiveness of culture supplement compositions 1000 in achieving taste alignment with the reference product. For example and without limitation, formulations such as P1_F4 and P1_F8 demonstrate positioning in the right quadrant of the PCA space, showing movement toward the reference product TP1 compared to the base product P1, which can indicate improved performance in generating taste compounds that contribute to dairy-like flavor characteristics. Additionally or alternatively, formulation P1_F9 shows positioning closer to the center of the PCA space, while other formulations such as P1_F1, P1_F2, P1_F3, P1_F5, P1_F6, P1_F7, P1_F10, and P1_F11 exhibit various degrees of movement within the PCA space, which can be used by processing circuitry 104 to rank the effectiveness of different culture supplement compositions 1000 based on ability to reduce compositional gaps and improve taste alignment with reference products.

Moreover, as embodied herein, the PCA taste maps shown in FIGS. 10A and 10B can provide a visualization tool for evaluating the success of manufacturing process adjustments in producing adjusted cellular agriculture products with improved taste characteristics. The electronic tongue system utilizing AHS, PKS, CTS, NMS, CPS, and SCS sensors can generate electronic signatures that correlate with human taste perception, which can provide objective measurements of taste attributes including sourness, bitterness, astringency, umami, and saltiness that can be stored as compositional profile data in memory 102. The two-dimensional representation of complex multi-sensor datasets can allow for rapid assessment of product similarity and identification of formulations that achieve desired improvement in taste alignment with reference dairy products.

Additionally or alternatively, as embodied herein, the PCA analysis demonstrated in FIGS. 10A and 10B can be integrated into method 200 for cellular attribute alignment by providing quantitative metrics for evaluating the effectiveness of manufacturing process adjustments in taste profile modification. The spatial coordinates of products in the PCA space can be stored in memory 102 as compositional profile data and used by processing circuitry 104 to iteratively optimize culture supplement formulations and processing conditions. The PCA approach can allow for systematic evaluation of multiple formulation variables together, which can facilitate efficient development of adjusted cellular agriculture products that achieve improved taste alignment with consumer preferences and reference product attributes while maintaining production efficiency and cellular viability in manufacturing component 108 operations.

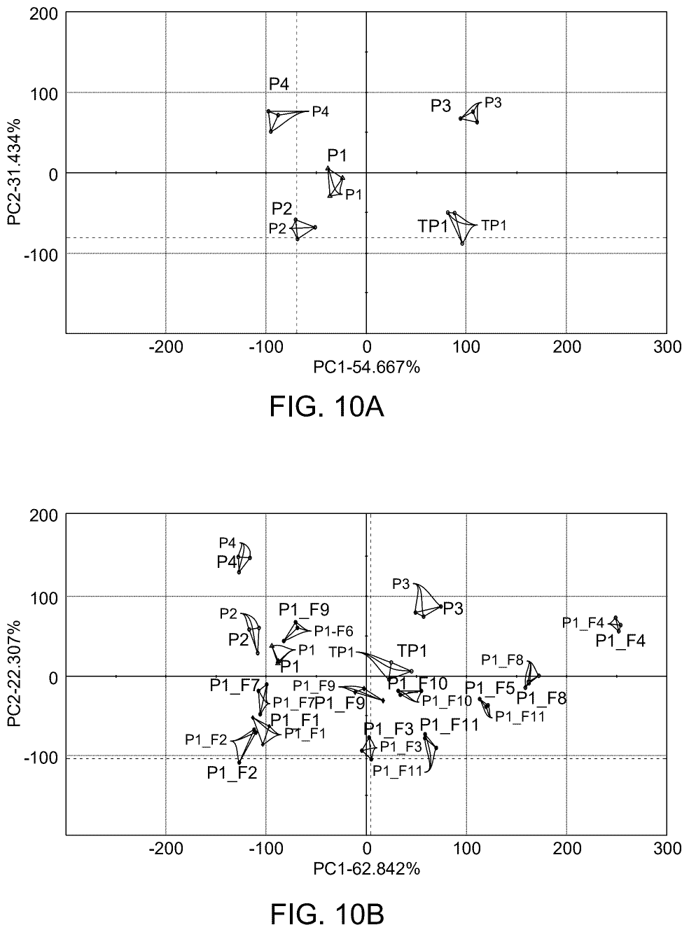

Referring now to FIGS. 11A-11C, for purpose of illustration and not limitation, quantitative taste attribute analyses are shown, illustrating relative taste rankings of sourness, saltiness, and sweetness respectively for Formulations 1-11 of Table 1 used to adjust base cellular dairy product P1 in accordance with the disclosed subject matter. As embodied herein, FIGS. 11A-11C illustrate taste profile data generated using standards addition methodology with galactose, sodium chloride (NaCl), and lactic acid as calibration standards to provide quantitative measurements of specific taste attributes that can be stored as compositional profile data in memory 102 and analyzed by processing circuitry 104 to evaluate the effectiveness of culture supplement compositions 1000 to increase or maximize taste alignment with reference dairy products.

As shown in FIG. 11A, sourness rankings are presented for the reference product TP1, base cellular agriculture products P1 through P4, and adjusted cellular agriculture products P1_F1 through P1_F11 using lactic acid as a calibrant in a concentration range from 0.001% to 0.005%. With reference to FIG. 11A, the sourness analysis illustrates that adjusted cellular agriculture products P1_F9 and P1_F3 can be considered to exhibit the closest alignment to the reference product TP1 in terms of sourness characteristics. For purpose of illustration and not limitation, as shown in FIG. 11A, the reference product TP1 shows a sourness ranking of approximately 6.5 on the standard addition taste scale, while P1_F9 and P1_F3 demonstrate sourness rankings of approximately 6.8 and 6.2 respectively, indicating improved performance of these formulations in generating lactic acid and other organic acids contributing to the characteristic tangy flavor notes associated with traditional dairy products.

Additionally or alternatively, as embodied herein, FIG. 11A illustrates the base cellular agriculture products P1 through P4 exhibit sourness rankings ranging from approximately 3.0 to 8.5 on the standard addition taste scale, which can be considered significant variability and as having compositional gaps compared to the reference product TP1. The adjusted cellular agriculture products treated with various culture supplement compositions 1000 show differential improvements in sourness alignment, with formulations such as P1_F1, P1_F2, P1_F4, P1_F5, P1_F6, P1_F7, P1_F8, P1_F10, and P1_F11 exhibiting sourness rankings ranging from approximately 3.5 to 10.5, which can be used by processing circuitry 104 to rank the effectiveness of different enzymatic formulations based on ability to generate desired sourness characteristics that align with consumer preferences for dairy products.

As shown in FIG. 11B, saltiness rankings are presented using sodium chloride (NaCl) as a calibrant in a concentration range from 0.05% to 0.5%. With reference to FIG. 11B, the saltiness analysis illustrates that adjusted cellular agriculture products P1_F9 and P1_F3 can be considered to exhibit the closest alignment to the reference product TP1 in terms of saltiness characteristics. For purpose of illustration and not limitation, as shown in FIG. 11B, the reference product TP1 shows a saltiness ranking of approximately 5.2 on the standard addition taste scale, while P1_F9 and P1_F3 demonstrate saltiness rankings of approximately 5.0 and 5.5 respectively, indicating that these formulations can generate sodium ions and other mineral compounds that contribute to the characteristic salty taste notes found in traditional dairy products.

Furthermore, as embodied herein, FIG. 11B illustrates the base cellular agriculture products P1 through P4 can exhibit saltiness rankings ranging from approximately 2.5 to 9.5 on the standard addition taste scale, which can be considered as compositional gaps in mineral content compared to the reference product TP1. The adjusted cellular agriculture products show varying degrees of improvement in saltiness alignment, with formulations such as P1_F1, P1_F2, P1_F4, P1_F5, P1_F6, P1_F7, P1_F8, P1_F10, and P1_F11 exhibiting saltiness rankings ranging from approximately 3.5 to 8.0, which can provide quantitative data that can be used by processing circuitry 104 to improve culture supplement compositions 1000 for increased mineral profile alignment with reference dairy products.

As shown in FIG. 11C, sweetness rankings are presented using galactose as a calibrant in a concentration range from 0.01% to 1%. With reference to FIG. 11C, the sweetness analysis illustrates that adjusted cellular agriculture products P1_F6, P1_F5, and P1_F4 can be considered to exhibit the closest alignment to the reference product TP1 in terms of sweetness characteristics. For purpose of illustration and not limitation, as shown in FIG. 11C, the reference product TP1 shows a sweetness ranking of approximately 4.2 on the standard addition taste scale, while P1_F6, P1_F5, and P1_F4 can have sweetness rankings of approximately 4.0, 4.5, and 4.1 respectively, indicating that these formulations can generate lactose, galactose, and other reducing sugars that contribute to the characteristic sweet taste notes associated with traditional dairy products.

Moreover, as embodied herein, FIG. 11C illustrates that the base cellular agriculture products P1 through P4 exhibit sweetness rankings ranging from approximately 2.5 to 5.0 on the standard addition taste scale, with P1 showing a sweetness ranking of approximately 2.5, which can be considered as compositional gaps in carbohydrate content compared to the reference product TP1. The adjusted cellular agriculture products illustrate differential improvements in sweetness alignment, with formulations such as P1_F1, P1_F2, P1_F3, P1_F7, P1_F8, P1_F9, P1_F10, and P1_F11 exhibiting sweetness rankings ranging from approximately 2.8 to 6.5, which can be used by processing circuitry 104 to identify improved enzymatic approaches for increasing alignment of carbohydrate profiles in cellular agriculture dairy products with reference products including traditional dairy products.

Additionally or alternatively, as embodied herein, the quantitative taste attribute analyses shown in FIGS. 11A-11C can provide data that can be used in method 200 for cellular attribute alignment, for example for use by processing circuitry 104 to evaluate the effectiveness of culture supplement compositions 1000 across one or more taste dimensions separately or in combination. The standards addition methodology using, for purpose of illustration and not limitation, lactic acid, sodium chloride, and galactose as calibrants can provide objective, reproducible measurements correlating with human taste perception and can be stored in memory 102 for iterative improvement of manufacturing process adjustments. As embodied herein, the differential performance of various formulations across sourness, saltiness, and sweetness attributes can be used by processing circuitry 104 to identify formulations, such as P1_F3 and P1_F9, that achieve desired alignment in selected taste categories, while formulations such as P1_F4, P1_F5, and P1_F6, for example exhibit increased effectiveness in sweetness enhancement, which can provide guidance for targeted improvement of culture supplement compositions 1000 to achieve taste profile alignment with reference dairy products while maintaining production efficiency and cellular viability in manufacturing component 108 operations.

Additionally or alternatively, as embodied herein, the digital nose system can be configured to identify and quantify a comprehensive array of volatile organic compounds (VOCs) that can contribute to the overall odor and flavor profiles of cellular agriculture products and reference products. For purpose of illustration and not limitation, extraction-quantification component 106 configured as an electronic nose system can identify up to 26 VOCs, including 6 aldehydes, 6 alcohols, 4 ketones, 4 esters, 5 acids, and 1 hydrocarbon that can be stored as compositional profile data in memory 102. As embodied herein, the aldehydes can include compounds such as hexanal, benzaldehyde, and other carbonyl-containing molecules that can be considered to contribute to buttery and nutty flavor characteristics, while the alcohols can include compounds such as ethanol, butanol, and other hydroxyl-containing molecules that can be considered to contribute to fruity and floral notes. The ketones can include compounds such as 2-heptanone and acetone derivatives that can be considered to contribute to creamy and dairy-like characteristics, while the esters can include compounds such as butyl butanoate and ethyl acetate that can be considered to contribute to sweet and fruity flavor notes.

Furthermore, as embodied herein, the acids identified by the electronic nose system can include organic acids such as butanoic acid, hexanoic acid, and acetic acid that can be considered to contribute to tangy and cheese-like flavor characteristics, while the hydrocarbon can include compounds that can be considered to contribute to the overall volatile profile complexity. The comprehensive identification of various combinations of the 26 VOCs can be used by processing circuitry 104 to perform detailed compositional gap analysis by comparing the relative concentrations of one or more compound class between base cellular agriculture products and reference products. As embodied herein, the differences in total levels of one or more of the VOCs can contribute to the misalignment of the overall odor profile and flavor profile of the base cellular dairy product compared to the reference dairy product, providing quantitative targets for manufacturing process adjustments using culture supplement compositions 1000.

Moreover, as embodied herein, the electronic tongue system results can illustrate that different enzyme processing formulations corresponding to the formulations of Table 1, and as embodied herein, can significantly affect both odor and taste presentation of adjusted cellular agriculture products. For purpose of illustration and not limitation, the electronic tongue sensors, which can include AHS, PKS, CTS, NMS, CPS, and SCS sensors, can generate taste profile data that correlates with the volatile organic compound profiles generated by the electronic nose system, which can be used by processing circuitry 104 to establish relationships between enzymatic treatments and olfactory and gustatory sensory attributes. The correlation between electronic nose and electronic tongue data can provide multi-sensory mapping that enables refinement of culture supplement compositions 1000 to achieve improvements in both odor and taste alignment with reference products.

Additionally or alternatively, as embodied herein, the taste performance analysis can illustrate that the sourness, sweetness, and saltiness of the base cellular dairy product can be improved with enzymatic treatments, using for example the formulations of Table 1 and as described herein. For example and without limitation, the standards addition methodology using lactic acid, galactose, and sodium chloride as calibrants can provide quantitative evidence that culture supplement compositions 1000 can generate taste-active compounds to reduce compositional gaps in taste attributes of interest. The enzymatic treatments can improve the generation of organic acids that contribute to sourness characteristics, carbohydrates and sugar derivatives that contribute to sweetness characteristics, and mineral compounds that contribute to saltiness characteristics, for purpose of illustration only and not limitation, thereby achieving comprehensive taste profile alignment with reference dairy products.

Furthermore, as embodied herein, the integrated analysis of combinations of the 26 VOCs identified by the electronic nose system and the taste attribute improvements exhibited by the electronic tongue system can provide processing circuitry 104 with a variety of sensory data for improving manufacturing process adjustments. For example and without limitation, the correlation between volatile compound classes and taste attribute improvements can be used for targeted formulation of culture supplement compositions 1000 that address both olfactory and gustatory compositional gaps. As embodied herein, such multi-sensory approaches can facilitate the development of adjusted cellular agriculture products that achieve improved sensory alignment with reference products across multiple sensory modalities while maintaining production efficiency and cellular viability in manufacturing component 108 operations.

According to other aspects of the disclosed subject matter, pea protein modification compositions include an enzyme blend including at least one of a transferase, a lyase, a hydrolase, and a phosphatase in a carrier, where the composition is configured to treat pea protein under controlled pH and temperature conditions to produce modified pea protein having reduced presence of at least one off-flavor compound selected from the group consisting of bitter compounds, beany compounds, and astringent compounds, compared to untreated pea protein.

According to other aspects of the disclosed subject matter, methods for producing modified pea protein include treating pea protein with an enzyme blend including at least one transferase, lyase, hydrolase, and phosphatase under controlled pH and temperature conditions, where the modified pea protein has reduced presence of at least one off-flavor compound selected from the group consisting of bitter compounds, beany compounds, and astringent compounds, compared to untreated pea protein.

According to other aspects of the disclosed subject matter, systems for producing modified pea protein include a reaction vessel configured to process pea protein with an enzyme blend, an enzymatic treatment module configured to introduce an enzyme blend including at least one transferase, lyase, hydrolase, and phosphatase, and a drying module configured to stabilize the treated protein into a modified pea protein product.

According to other aspects of the disclosed subject matter, modified pea protein products are provided. In accordance with the disclosed subject matter herein, a modified pea protein product is produced using a pea protein modification composition including an enzyme blend including at least one of a transferase, a lyase, a hydrolase, and a phosphatase in a carrier, where the composition is configured to treat a pea protein under controlled pH and temperature conditions to produce a modified pea protein having reduced presence of at least one off-flavor compound selected from the group consisting of bitter compounds, beany compounds, and astringent compounds, compared to untreated pea protein, where the modified pea protein product has reduced presence of at least one off-flavor compound selected from the group consisting of bitter compounds, beany compounds, and astringent compounds, compared to the unmodified pea protein.

According to other aspects of the disclosed subject matter, by way of example only and not limitation, an enzymatic approach to processing legume proteins is provided, including for example by utilizing one or more targeted enzyme blends that can reduce undesirable flavors or off-notes. Such techniques can also increase soluble fiber content compared to conventional legume proteins. Thus, the sensory and nutritional properties of legume proteins can be improved while reducing or eliminating the use of physical or chemical modifications to the proteins. Moreover, while the exemplary systems, methods, and compositions are described herein, for purpose of illustration and not limitation, to reduce undesirable flavors or off-notes, it is understood that additionally or alternatively the systems, methods, and compositions disclosed herein can be used to increase presence or perception of desirable flavors of products made using legume proteins in accordance with the disclosed subject matter, or to substantially eliminate off-flavor compounds to achieve neutral flavor profiles suitable for ingredient applications where reduced or minimized flavor interference is desired.

As embodied herein, systems, methods, and compositions presented herein can provide an enzymatic approach for improving pea protein, including for example by selectively reducing undesirable flavors or off-notes to achieve either alignment with traditional protein product characteristics or neutral flavor profiles for ingredient applications. Such systems, methods and compositions can also increase solubility, for example and without limitation through a targeted breakdown of anti-nutritional components and conversion of insoluble fiber into soluble fiber. Additionally or alternatively, as embodied herein, an enzyme blend can include one or more of a transferase, a lyase, a hydrolase, and a phosphatase, and can be used to modify pea protein in a controlled enzymatic process. The disclosed enzymatic treatments can alter the molecular composition of pea protein, which can reduce undesirable sensory attributes to achieve desired flavor profiles or substantially eliminate off-flavor compounds to achieve neutral sensory characteristics, and can increase soluble fiber, thus contributing to improved gut health and protein digestibility.

Furthermore, as embodied herein, the systems, methods and compositions presented herein can include an enzymatic approach for adjusting leguminous proteins, including by selectively reducing undesirable flavors or off-notes, which can increase digestibility, and increase soluble fiber content. This approach thus can include an enzymatic modification of undesirable flavor precursors, degradation of anti-nutritional compounds, and can include conversion of insoluble fiber fractions into soluble fiber. The enzymatic modifications can be targeted toward achieving alignment with consumer preferences for traditional protein products or toward achieving neutral flavor profiles with reduced or substantially eliminated bitter, beany, astringent, or grassy characteristics suitable for versatile ingredient applications. For purpose of illustration of the disclosed subject matter, and not limitation, an exemplary enzymatic treatment method can include enzymatically treating leguminous protein materials, including pea protein (Pisum sativum), mung bean protein (Vigna radiata), and fava bean protein (Vicia faba), to reduce undesirable flavors or off-notes. Such techniques can also increase soluble fiber content, which can improve digestibility.

As embodied herein, exemplary methods can include selecting a leguminous protein substrate, which can include flour, concentrate, isolate, or textured protein. An enzyme blend can include one or more of a transferase, a lyase, a hydrolase, and a phosphatase, and can be applied to the protein. For example and as embodied herein, the enzyme blend can be applied under controlled reaction conditions. Additionally or alternatively, as embodied herein, the transferase can facilitate transfer of functional groups to modify bitter compounds, which can contribute to achieving neutral flavor profiles by substantially eliminating bitterness. The lyase can catalyze the cleavage of specific bonds to degrade volatile and non-volatile flavor precursors that contribute to beany, grassy, or other undesirable sensory characteristics. Hydrolases, including but not limited to carbohydrolases and proteases, can hydrolyze oligosaccharides, complex carbohydrates, and peptide bonds, can reduce anti-nutritional factors and increase fiber solubility. Phosphatases, such as phytases, can hydrolyze phytic acid and other phosphate-containing anti-nutritional factors can improve mineral bioavailability and digestibility.

Moreover, as embodied herein, the enzymatic methods described herein can be conducted at a pH range of 5.0 to 7.5, and a temperature range of 20° C. to 45° C. for a reaction time of 30 minutes to 6 hours. As such, suitable enzyme activity can be obtained without compromising protein integrity. Post-reaction processing can include filtration, drying, or spray-drying. The exemplary methods described herein can thus yield a stable, high-quality leguminous protein product suitable for commercial applications, including both direct consumer products with enhanced sensory characteristics and neutral ingredient bases for end-product manufacturing.

Additionally or alternatively, as embodied herein, according to another example of the disclosed subject matter, for purpose of illustration and not limitation, a pea protein isolate can be treated with an enzyme blend including one or more transferases, lyases, hydrolases, and phosphatases. The enzymatic reaction can occur in an aqueous medium maintained at a pH range of 5.0 to 7.5 and a temperature range of 18-30° C. for a duration of 1-4 hours. In this example, there can be a significant reduction in bitter, beany, or grassy off-notes, along with a 10-50% increase in soluble fiber content, improving both flavor and digestibility of the protein. The degree of off-flavor reduction can be controlled to achieve either improved palatability for direct consumption or neutral flavor profiles suitable for ingredient applications where manufacturers desire reduced or minimized flavor interference.

Furthermore, as embodied herein, according to another example of the disclosed subject matter, for purpose of illustration and not limitation, a pea protein concentrate can be subjected to a similar enzymatic treatment under controlled conditions, followed by spray-drying. In this example, a stable, powdered protein ingredient can be produced with reduced or substantially eliminated off-flavors suitable for neutral ingredient applications. The solubility and sensory properties of pea protein can thus be improved, which can be suitable for incorporation, for example and without limitation, in plant-based beverages such as protein shakes, dairy alternatives, and functional nutritional drinks, as well as ingredient bases for custom flavoring by end-product manufacturers.

Moreover, as embodied herein, according to another example of the disclosed subject matter, for purpose of illustration and not limitation, enzymatic processing of a mung bean protein concentrate can include using an enzyme blend including methyltransferase, sulfur lyase, beta-glucosidase, and phytase. The enzymatic reaction can occur at a pH range of 5.5-7.0 and a temperature range of 25-40° C. for 2-6 hours. In this example, bitter and grassy flavors can be reduced to achieve neutral sensory characteristics, and oligosaccharides, which can contribute to digestive discomfort, can be hydrolyzed. Thus, an improved protein ingredient can be provided with neutral flavor profiles, which can be used for example and without limitation in plant-based egg substitutes, savory snacks, and nutritional supplements, or as ingredient bases for custom formulation applications.

Additionally or alternatively, as embodied herein, according to another example of the disclosed subject matter, for purpose of illustration and not limitation, fava bean protein can be treated with an enzyme blend including aminotransferase, pectin lyase, glycosyltransferase, and phytase in an aqueous medium with a controlled pH of 4.5-7.0 and a temperature of 30-45° C. for 1-5 hours. In this example, polyphenol-associated astringency can be reduced or substantially eliminated and soluble fiber content can be increased. Thus, a protein can be provided with neutral flavor characteristics and improved texture, which can be suitable for example and without limitation for use in plant-based meat analogs, emulsified sauces, and protein-rich bakery products, as well as neutral ingredient bases for a variety of food manufacturing applications.

Furthermore, as embodied herein, according to another example of the disclosed subject matter, for purpose of illustration and not limitation, a multi-enzyme treatment of a blend of pea, mung bean, and fava bean proteins can improve sensory attributes and nutritional value of the blend to achieve neutral flavor profiles. The treatment can include exposure to a transferase, lyase, hydrolase, and phosphatase in a reaction vessel at pH 5.0-7.5 and a temperature range of 20-40° C. for up to 6 hours. The resulting protein blend can exhibit reduced or substantially eliminated undesirable flavor or off-notes, increased solubility, and enhanced prebiotic fiber content. Thus, the resulting protein can be suitable for example and without limitation for plant-based protein bars, nutritional powders, and functional food applications, as well as neutral ingredient bases that enable complete control over final product flavoring.

Moreover, as embodied herein, according to another example of the disclosed subject matter, for purpose of illustration and not limitation, an exemplary embodiment can include a continuous enzymatic processing system, which can be configured for large-scale production of legume proteins according to the disclosed subject matter, which can have reduced undesirable flavors or off-notes or neutral flavor profiles suitable for ingredient applications. The system can include an enzymatic treatment module configured to introduce a selected dosage of a multi-enzyme blend, a reaction chamber to maintain desired processing conditions, and a downstream filtration and drying unit to stabilize the processed protein. This system can provide efficient, scalable production of clean-label, plant-based proteins with improved sensory and functional properties or neutral sensory characteristics in accordance with the disclosed subject matter.

Additionally or alternatively, as embodied herein, systems, methods and compositions disclosed herein can provide an effective and natural approach to improving the taste and digestibility of food products including pea protein, or to achieving neutral flavor profiles suitable for ingredient applications. Using the systems, methods and compositions, manufacturers can achieve cleaner-label solutions with improved sensory and functional properties, which can broaden the consumer appeal of pea protein in plant-based food applications, or can produce neutral ingredient bases that enable custom flavoring and formulation flexibility. The disclosed subject matter can provide enzymatic modifications of pea protein to improve sensory and functional properties of pea protein without the need for artificial additives, or to substantially eliminate off-flavor compounds to achieve neutral sensory characteristics. The disclosed subject matter thus can provide a cost-effective, scalable, and clean-label alternative to conventional flavor-masking or chemical treatments.

Furthermore, as embodied herein, systems, methods, and compositions disclosed herein can provide a reduction of undesirable flavors or off-notes through targeted enzymatic modification, including substantial elimination of such compounds to achieve neutral flavor profiles. The disclosed subject matter thus can effectively reduce bitterness, beany flavors, and astringency, resulting in either a more pleasant taste profile for pea protein-based products or neutral sensory characteristics suitable for ingredient applications where reduced or minimized flavor interference is desired. The disclosed subject matter can improve solubility, for example by utilizing phytase and hydrolase to break down anti-nutritional factors. These enzymes can thus improve solubility of the proteins, which can facilitate incorporation of the proteins into a variety of plant-based food applications with improved consistency and texture.

Moreover, as embodied herein, the enzymatic reactions described in the systems and methods of disclosed subject matter can increase soluble fiber by facilitating the conversion of insoluble fiber fractions into soluble forms. This transformation can improve the nutritional profile of pea protein, which can provide improved gut health benefits for consumers. The disclosed subject matter can support clean-label processing by avoiding the need for artificial flavoring agents or chemical processing. Manufacturers can utilize the disclosed subject matter to achieve high-quality sensory and functional outcomes while maintaining a cleaner ingredient list, including for direct consumer products and for neutral ingredient bases for end-product manufacturing.

Additionally or alternatively, as embodied herein, systems, methods, and compositions disclosed herein can be used for a wide variety of applications, including applications of plant-based food products and neutral ingredient bases for commercial manufacturing. For purpose of illustration and not limitation, the disclosed subject matter can include plant-based meat analogs, dairy alternatives such as plant-based yogurts, cheeses, and protein beverages. Additionally or alternatively, as embodied herein, the disclosed subject matter can be used for nutritional and sports supplements. Furthermore, or as a further alternative, the disclosed subject matter can be used to create functional foods with prebiotic benefits, or neutral protein ingredient bases that enable custom flavoring by food manufacturers, supplement producers, and other end-product developers.

Furthermore, as embodied herein, the applications of the disclosed subject matter can include any food products benefiting from improved taste and texture to enhance consumer appeal, increased solubility and reduced undesirable flavors or off-notes, a cleaner-label protein source with improved functionality, increased soluble fiber to promote gut health while maintaining high sensory quality, or neutral flavor profiles that enable ingredient versatility for a variety of commercial applications. For example and not limitation, as embodied herein, Table 2 can include exemplary formulations for compositions in accordance with the disclosed subject matter. As shown for example in Table 2, the exemplary formulations can include the corresponding components, at any of the corresponding ratios (if applicable), and having an inclusion amount in the corresponding ranges.

TABLE 2

| | | | Exemplary |
|---|---|---|---|
| | | | Inclusion |
| | | Exemplary | Amount(s) - |
| Formulation | Components | Ratio(s) | Range |
| Enzyme | 1% w/v | 0.33:0.33:0.34, | 0.1% to 2% |
| Cocktail I | Transferase, | 0.4:0.35:0.25, | |
| | Telopeptidase, and | 0.5:0.3:0.2, | |
| | Hydrolase | 0.45:0.35:0.2 | |
| Enzyme | 1% w/v Hydrolase, | 0.5:0.5, | 0.1% to 2% |
| Blend I | Transferase | 0.6:0.4, | |
| | | 0.7:0.3, | |
| | | 0.8:0.2, | |
| | | 0.9:0.1 | |
| Enzyme | 1% w/v | 0.5:0.5, | 0.1% to 5% |
| Blend II | Transferase, | 0.6:0.4, | |
| | Aminopeptidases | 0.7:0.3, | |
| | | 0.8:0.2, | |
| | | 0.9:0.1 | |
| Enzyme | 1% w/v | 0.33:0.33:0.34, | 0.1% to 2% |
| Blend III | Transferase, | 0.4:0.35:0.25, | |
| | Aminopeptidases, | 0.5:0.3:0.2, | |
| | Hydrolase | 0.45:0.35:0.2, | |
| | | 0.6:0.3:0.1, | |
| | | 0.7:0.2:0.1, | |
| | | 0.8:0.15:0.05, | |
| | | 0.1:0.3:0.6, | |
| | | 0.2:0.4:0.4, | |
| | | 0.25:0.35:0.4, | |
| Enzyme | 1% w/v | 0.25:0.25:0.25:0.25, | 0.1% to 5% |
| Blend IV | Transferase, | 0.4:0.3:0.2:0.1, | |
| | Aminopeptidase, | 0.35:0.25:0.25:0.15, | |
| | Hydrolase, Lyase | 0.5:0.2:0.2:0.1, | |
| | | 0.6:0.2:0.1:0.1, | |
| | | 0.7:0.15:0.1:0.05, | |
| | | 0.8:0.1:0.05:0.05, | |
| | | 0.1:0.2:0.3:0.4, | |
| | | 0.05:0.15:0.25:0.55, | |
| | | 0.2:0.3:0.3:0.2 | |
| Enzyme | 1% w/v | 0.2:0.2:0.2:0.2:0.2, | 0.1% to 2% |
| Blend V | Transferase, | 0.3:0.25:0.2:0.15:0.1, | |
| | Aminopeptidase, | 0.4:0.2:0.15:0.15:0.1, | |
| | Hydrolase, Lyase, | 0.35:0.25:0.2:0.1:0.1, | |
| | Phosphatase | 0.5:0.2:0.1:0.1:0.1, | |
| | | 0.6:0.15:0.1:0.1:0.05, | |
| | | 0.7:0.1:0.08:0.07:0.05, | |
| | | 0.05:0.1:0.2:0.25:0.4, | |
| | | 0.1:0.15:0.2:0.25:0.3 | |
| Enzyme | 1% w/v | 0.2:0.2:0.2:0.2:0.2 | 0.1% to 2% |
| Blend VI | Transferase, | 0.3:0.25:0.2:0.15:0.1 | |
| | Aminopeptidase, | 0.4:0.2:0.15:0.15:0.1 | |
| | Hydrolase, Lyase, | 0.35:0.25:0.2:0.1:0.1 | |
| | Oxidoreductase | 0.5:0.2:0.1:0.1:0.1 | |
| | | 0.6:0.15:0.1:0.1:0.05 | |
| | | 0.7:0.1:0.08:0.07:0.05 | |
| | | 0.05:0.1:0.2:0.25:0.4 | |
| | | 0.1:0.15:0.2:0.25:0.3 | |
| Enzyme | 1% w/v | 0.2:0.2:0.2:0.2:0.2 | 0.1% to 2% |
| Blend VII | Transferase, | 0.3:0.25:0.2:0.15:0.1 | |
| | Aminopeptidase, | 0.4:0.2:0.15:0.15:0.1 | |
| | Hydrolase, Lyase, | 0.35:0.25:0.2:0.1:0.1 | |
| | Glycosidase | 0.5:0.2:0.1:0.1:0.1 | |
| | | 0.6:0.15:0.1:0.1:0.05 | |
| | | 0.7:0.1:0.08:0.07:0.05 | |
| | | 0.05:0.1:0.2:0.25:0.4 | |
| | | 0.1:0.15:0.2:0.25:0.3 | |

Moreover, as embodied herein, the enzymatic processing approaches for leguminous proteins can be integrated with system 100 and method 200 for cellular attribute alignment by utilizing processing circuitry 104 to analyze compositional profiles of leguminous protein substrates and reference products stored in memory 102, or to achieve neutral flavor profiles through substantial elimination of off-flavor compounds. For purpose of illustration and not limitation, extraction-quantification component 106 can be configured to generate compositional profile data for leguminous proteins before and after enzymatic treatment, enabling processing circuitry 104 to quantify improvements in flavor attributes, soluble fiber content, and digestibility parameters, or to verify achievement of neutral sensory characteristics suitable for ingredient applications. The enzymatic treatment parameters including pH, temperature, reaction time, and enzyme concentrations can be optimized using processing circuitry 104 to achieve targeted improvements in sensory and nutritional attributes while maintaining protein functionality and production efficiency in manufacturing component 108 operations.

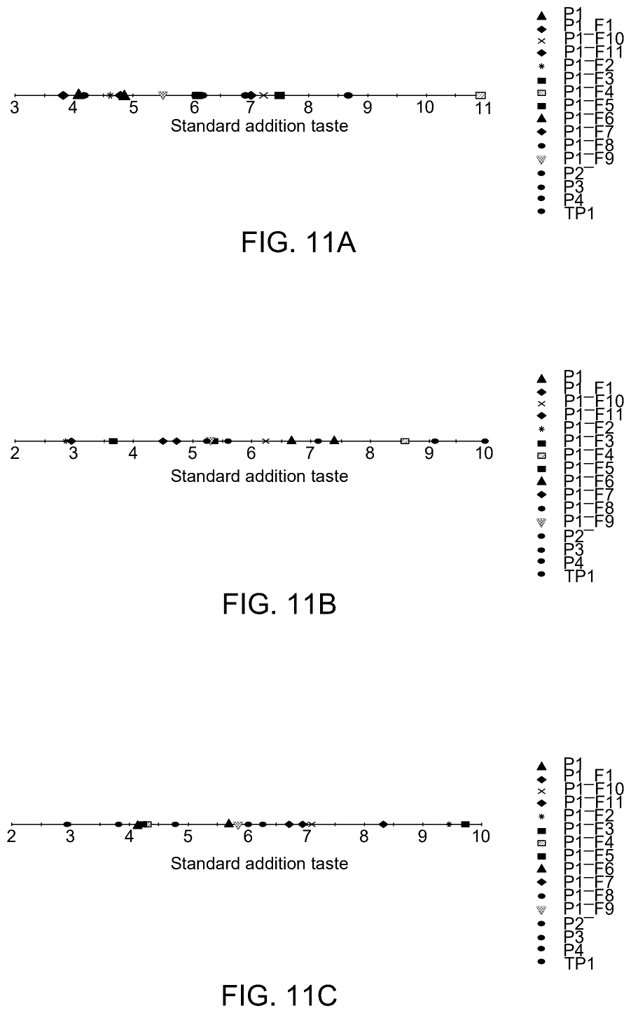

Referring now to FIG. 12, for purpose of illustration and not limitation, exemplary embodiments of flavor profiles of a base cellular agriculture product and adjusted cellular agriculture products are shown in accordance with the disclosed subject matter. As embodied herein, FIG. 12 illustrates a radar plot analysis of six flavor aspects presented in a hexagonal configuration, illustrating multi-dimensional sensory characteristics of pea protein isolate (PPI) samples before and after enzymatic treatment. The radar plot can provide a comprehensive visualization of flavor intensity measurements across each category, including saltiness, bitterness, sweetness, astringency, umami, and overall flavor intensity, with each attribute measured on a 5-point intensity scale where 1 represents low intensity and 5 represents high intensity. The substantial reductions in bitterness and astringency levels demonstrated in FIG. 12 provide support for achieving neutral flavor profiles suitable for ingredient applications, where off-flavor compounds are reduced to levels that enable custom flavoring by end-product manufacturers.

As shown in FIG. 12, the untreated PPI (represented by the long-dashed line) can exhibit a characteristic flavor profile with elevated bitterness levels at approximately 4.5 on the intensity scale, which can be associated with undesirable sensory attributes of the leguminous proteins. Additionally or alternatively, as embodied herein, the untreated PPI can show moderate levels of astringency at approximately 3.0, umami characteristics at approximately 2.5, and overall flavor intensity at approximately 4.5, while having relatively low levels of saltiness at approximately 1.5 and sweetness at approximately 1.0. The flavor profile of untreated PPI can illustrate compositional gaps in sensory attributes that can lead to consumer rejection of plant-based protein products compared to traditional protein sources, and can demonstrate the need for substantial off-flavor reduction to achieve neutral ingredient bases suitable for commercial applications.

Furthermore, as embodied herein, FIG. 12 illustrates effectiveness of enzymatic treatments using Enzyme Blend III+PPI (represented by the short-dashed line) and Enzyme Blend IV+PPI (represented by the dotted line) in modifying the sensory characteristics of the base pea protein isolate. With reference to FIG. 12, the Enzyme Blend III treatment can achieve reduction in bitterness levels to approximately 2.0 on the intensity scale, representing a greater than 50% reduction compared to the untreated PPI. Additionally or alternatively, the Enzyme Blend Ill treatment can reduce astringency levels to approximately 1.5, while maintaining umami characteristics at approximately 2.0 and overall flavor intensity at approximately 3.0, which can be indicative of progress toward neutral flavor profiles suitable for ingredient applications where reduced or minimized off-flavor interference is desired.

Moreover, as shown in FIG. 12, and as embodied herein, Enzyme Blend IV treatment can show similar effectiveness in reducing undesirable flavor attributes, with bitterness levels reduced to approximately 1.5 and astringency levels reduced to approximately 1.0, which can represent substantial elimination of off-flavor compounds approaching neutral sensory characteristics. Enzyme Blend IV treatment can maintain umami characteristics at approximately 1.5 and overall flavor intensity at approximately 2.5, while showing minimal changes in saltiness and sweetness levels. The low levels of bitterness and astringency achieved through Enzyme Blend IV treatment demonstrate the feasibility of producing neutral flavor profile pea protein suitable for ingredient applications where manufacturers desire reduced or minimized flavor interference. The comparative analysis illustrated in FIG. 12 can be used by processing circuitry 104 to evaluate the relative effectiveness of different enzyme formulations in achieving targeted sensory improvements and can be stored as compositional profile data in memory 102 for improvement and refinement of culture supplement compositions 1000.

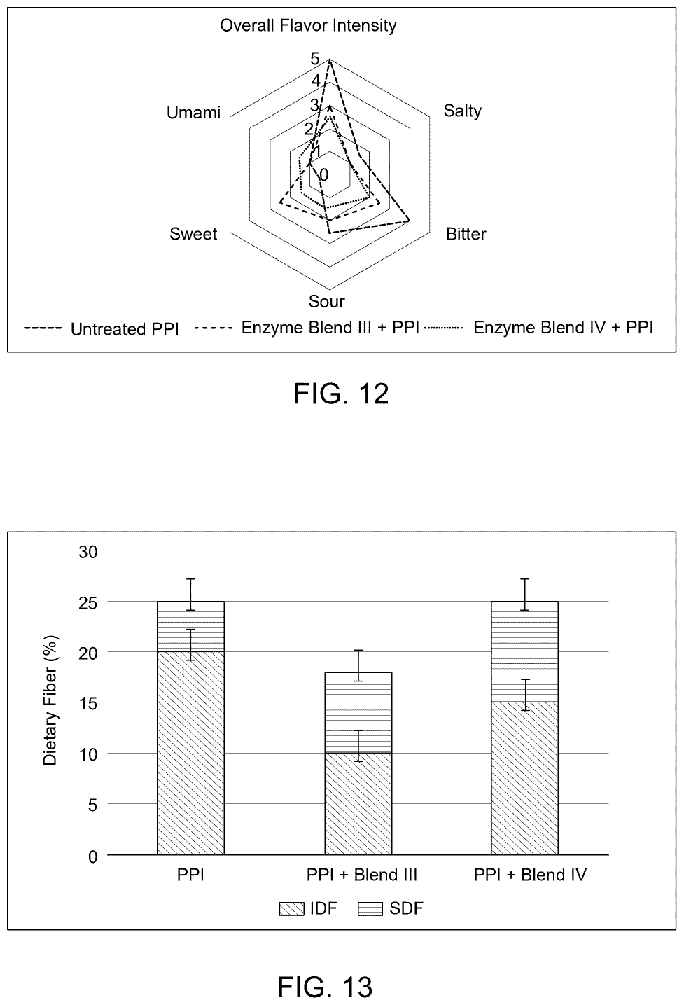

Referring now to FIG. 13, for purpose of illustration and not limitation, additional details of compositional profiles of the base cellular agriculture product and the adjusted cellular agriculture products of FIG. 12 are shown, illustrating dietary fiber composition analysis in accordance with the disclosed subject matter. As embodied herein, FIG. 13 illustrates the content of soluble dietary fiber (SDF) and insoluble dietary fiber (IDF) expressed as percentage by weight per 100 grams of freeze-dried PPI samples with and without enzyme treatment, including standard deviation measurements to show reproducibility of the enzymatic processing results.

As shown in FIG. 13, the untreated PPI can exhibit a total dietary fiber content of approximately 25% by weight, including approximately 20% insoluble dietary fiber (represented by the diagonal striped pattern) and approximately 5% soluble dietary fiber (represented by the horizontal striped pattern). The baseline fiber composition can show the predominance of insoluble fiber fractions in conventional pea protein isolates, which can contribute to reduced digestibility and limited prebiotic functionality compared to soluble fiber components that can provide enhanced gut health benefits.

Additionally or alternatively, as embodied herein, FIG. 13 demonstrates the effectiveness of enzymatic treatments in converting insoluble fiber fractions into soluble forms, which can improve the nutritional profile and functional properties of the pea protein isolate. The PPI+Blend Ill treatment can achieve a reduction in total dietary fiber content to approximately 18% by weight, including approximately 10% insoluble dietary fiber and approximately 8% soluble dietary fiber. This enzymatic treatment can thus represent a 50% reduction in insoluble fiber content and a 60% increase in soluble fiber content compared to the untreated PPI, which can indicate successful conversion of fiber fractions through targeted enzymatic hydrolysis.

Furthermore, as embodied herein, the PPI+Blend IV treatment can show similar effectiveness in fiber fraction conversion, for example achieving a total dietary fiber content of approximately 25% by weight, including approximately 15% insoluble dietary fiber and approximately 10% soluble dietary fiber. The Blend IV treatment can achieve a 25% reduction in insoluble fiber content and a 100% increase in soluble fiber content compared to the untreated PPI, which can represent a largest improvement in soluble fiber generation among the tested formulations. The enhanced soluble fiber content can contribute to improved digestibility, prebiotic functionality, and gut health benefits for consumers of the adjusted cellular agriculture protein products.

Moreover, as embodied herein, the dietary fiber analysis illustrated in FIG. 13 can provide quantitative data showing that the enzymatic treatments described herein can achieve benefits including sensory improvement and nutritional enhancement without compromising the total protein content or functional properties of the pea protein isolate. The conversion of insoluble fiber fractions into soluble forms can be facilitated by hydrolase and carbohydrolase enzymes included in the enzyme blends, which can selectively cleave glycosidic bonds in complex carbohydrates and oligosaccharides to generate smaller, more digestible fiber components. The quantitative fiber composition data can be stored in memory 102 and analyzed by processing circuitry 104 to refine and improve enzymatic treatment parameters and formulations for achieving targeted nutritional improvements in cellular agriculture protein products while maintaining production efficiency and cost-effectiveness in manufacturing component 108 operations.

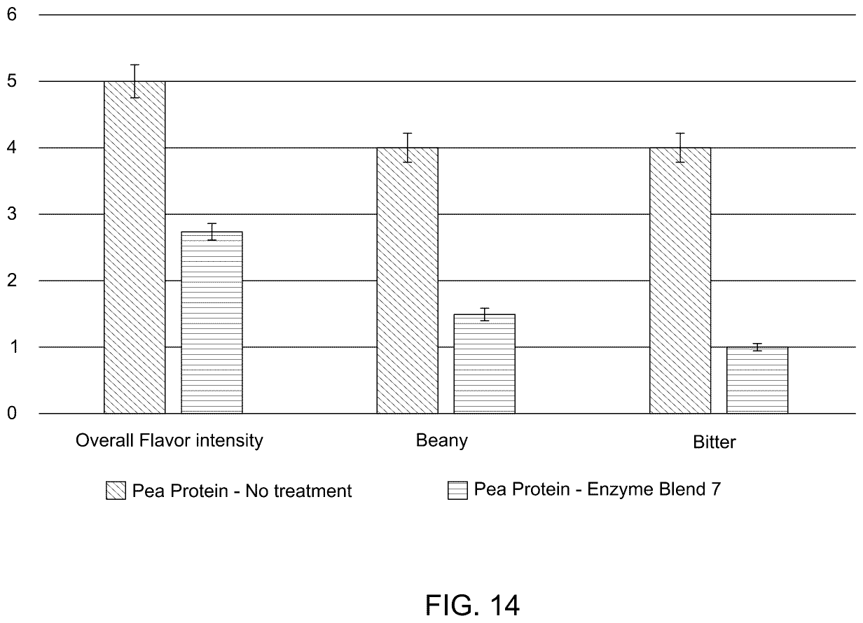

Referring now to FIG. 14, for purpose of illustration and confirmation of the disclosed subject matter, the effectiveness of enzyme blends in modifying sensory attributes of pea protein products can be shown through analytical evaluation. For example and as embodied herein, FIG. 14 shows exemplary results provided using Enzyme Blend 7 according to the disclosed subject matter on sensory attributes of a pea protein product. As embodied herein, attributes can be scored on an intensity scale, for example a 0 to 5 scale shown in FIG. 14, by untrained panelists under blinded, duplicate conditions. With reference to FIG. 14, treatment with the enzyme blend can result in a reduction in bitterness and an overall improvement in flavor profile, which can be effective to mitigate off-flavor compounds in pea protein formulations.

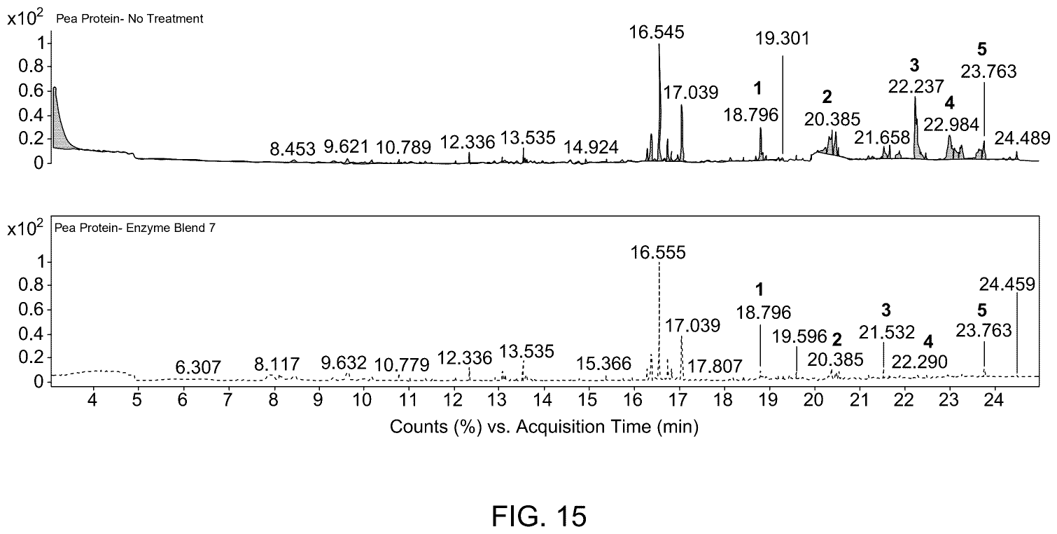

Referring now to FIG. 15, as embodied herein, the activity of enzyme blends according to the disclosed subject matter can be confirmed through chemical analysis of volatile compounds associated with off-notes. For purpose of illustration and confirmation, and not limitation, FIG. 15 shows results of exemplary headspace SPME-GC/MS analysis for an untreated pea protein overlaid above analysis after treatment with Enzyme Blend 7 for purpose of comparison, which shows exemplary results using Enzyme Blend 7 to reduce levels of several compounds associated with off-notes. As embodied herein, peaks 1 through 5 can correspond to the following: peak 1 can be Hexadecanoic acid, peak 2 can be Octadecenoic acid, peak 3 can be Heneicosanoic acid, peak 4 can be Octadien-2-one, and peak 5 can be Methoxypyrazine. The data can show a measurable decrease in these compounds in enzyme-treated pea protein isolates, which can further confirm the effectiveness of the disclosed subject matter to improve sensory quality of cellular agriculture protein products.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1-165. (canceled)

166. A pea protein modification composition, comprising:
an enzyme blend including at least one of a transferase, a lyase, a hydrolase, and a phosphatase in a carrier;
wherein the composition is configured to treat pea protein under controlled pH and temperature conditions to produce modified pea protein having reduced presence of at least one off-flavor compound compared to untreated pea protein, the at least one off-flavor compound selected from the group consisting of bitter compounds, beany compounds, and astringent compounds.

167. The composition of claim 166, wherein the transferase is selected from the group consisting of methyltransferases, aminotransferases, and glycosyltransferases.

168. The composition of claim 166, wherein the lyase is selected from the group consisting of sulfur lyases and pectin lyases.

169. The composition of claim 166, wherein the hydrolase is selected from the group consisting of beta-glucosidases, beta-fructofuranosidase, alpha-galactosidases, and proteases.

170. The composition of claim 166, wherein the phosphatase is a phytase.

171. The composition of claim 166, wherein the controlled pH conditions comprise a pH within a range of 5.0 to 7.5.

172. The composition of claim 166, wherein the controlled temperature conditions comprise a temperature within a range of 18° C. to 35° C.

173. The composition of claim 166, wherein the composition is configured to treat the untreated pea protein for a duration of 1 to 4 hours.

174. The composition of claim 166, wherein the composition is configured to increase soluble fiber content in the modified pea protein by about 10% to 50% compared to the untreated pea protein.

175. The composition of claim 166, wherein the composition is configured to reduce the presence of the at least one off-flavor compound by at least 20% compared to the untreated pea protein.
